(19) United States
(12) Patent Application Publication
(10) Pub. No.: US 2024/0220964 A1
(43) Pub. Date: Jul. 4, 2024

(54) SYSTEMS, METHODS, AND STORAGE MEDIA FOR CONFIGURING A DATA STORAGE AND RETRIEVAL SYSTEM FOR MANAGING DATA RELATING TO TOKENIZED ASSETS

(71) Applicant: Securrency, Inc., Annapolis, MD (US)

(72) Inventors: George Daniel Doney, Riva, MD (US); Ihor Yermakov, Arlington, VA (US)

(73) Assignee: Securrency, Inc., Annapolis, MD (US)

(21) Appl. No.: 18/220,610

(22) Filed: Jul. 11, 2023

Related U.S. Application Data
(63) Continuation-in-part of application No. 16/851,184, filed on Apr. 17, 2020, now abandoned.
(60) Provisional application No. 62/834,999, filed on Apr. 17, 2019.

(51) Int. Cl. G06Q 20/36; G06Q 20/40

(52) U.S. Cl. CPC G06Q 20/367; G06Q 20/40; G06Q 2220/00

(57) ABSTRACT

A distribution framework for facilitating decentralized asset management for individual assets and composite assets such as funds. The framework implements smart contract interfaces to link fungible tokens to non-fungible asset tokens to decouple securities transaction logic and corporate functions from asset management to facilitate code reuse. Additionally, the embodied process uses token nesting to enable homogeneous or heterogeneous assets to be combined into a fund structure, and further for funds to be composed into fund of fund models. The flexible structure enables the analysis of complex fund types and valuation thereof, while allowing fund management. The fund structure is further designed to facilitate broad investor access to innovative asset management strategies that leverage the disclosed structure.

### CROSS REFERENCES TO RELATED APPLICATIONS

This application is related to and claims priority from the following U.S. patents and patent applications. This application is a continuation-in-part of U.S. application Ser. No. 16/851,184, filed Apr. 17, 2020, which claims priority to and the benefit of U.S. Provisional Application No. 62/834,999, filed Apr. 17, 2019, each of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### 1. Field of the Invention

The present invention relates to a system for managing data relating to tokenized assets and more specifically to systems, methods, and storage media for configuration of a system thereof.

### 2. Description of the Prior Art

It is generally known in the prior art to provide systems for tokenization of assets and management of tokenized assets.

Prior art patent documents include the following:

US Patent Pub. No. 2022/0271915 for Advanced Non-Fungible Token Blockchain Architecture by inventors Turner et al., filed on Feb. 23, 2021 and published Aug. 25, 2022, is directed to methods and systems which may implement non-fungible tokens that implement a programmable grammar-based syntax in a variety of environments. In an embodiment, a first non-fungible token that implements a programmable grammar-based syntax standard and includes a first updatable programmable section is generated. The first non-fungible token includes at least one of first executable instructions or first data, and a first portion of the at least one of the first executable instructions or the first data is stored, according to the grammar-based syntax standard, in the first updatable programmable section. The first non-fungible token is operable to then be stored at a first blockchain address on a blockchain, and the first portion of the at least one of the first executable instructions or the first data in the first updatable programmable section of the first non-fungible token is subsequently changed to at least one of second executable instructions or second data.

US Patent Pub. No. 2022/0006705 for Systems, Methods, And Apparatuses For Implementing A Metadata Driven Rules Engine On Blockchain Using Distributed Ledger Technology (Dlt) by inventor Padmanabahn, filed Jun. 15, 2021 and published Jan. 6, 2022, is directed to systems, methods, and apparatuses for implementing a metadata driven rules engine on blockchain using Distributed Ledger Technology (DLT) in conjunction with a cloud based computing environment. For example, according to one embodiment there is a system having at least a processor and a memory therein executing within a host organization, in which such a system includes means for operating a blockchain interface to a blockchain on behalf of a plurality of tenants of the host organization, wherein each one of the plurality of tenants operate as one of a plurality of participating nodes on the blockchain having access to the blockchain; displaying a Graphical User Interface (GUI Interface) to a user device communicably interfaced with the system over a network, wherein the GUI interface is to prompt for a metadata rule definition at the user device when displayed by the user device; receiving input at the system from the GUI interface displayed to the client device, the input defining the metadata rule definition, wherein the metadata rule definition includes one or more conditions or criteria to be matched to a transaction received at the blockchain; auto-generating code for a smart contract representing the metadata rule definition based on the input received from the GUI interface displayed to the client device; submitting the smart contract having the code representing the metadata rule definition to the blockchain for consensus by participating nodes of the blockchain; and adding the smart contract having the code representing the metadata rule definition onto the blockchain by writing the metadata rule definition into an asset of a new block on the blockchain pursuant to the smart contract attaining consensus from the participating nodes of the blockchain. Other related embodiments are disclosed.

US Patent Pub. No. 2020/0349562 for Extensible template for asset token by inventors Madhuram et al., filed Oct. 3, 2019 and published Nov. 5, 2020 is directed to a computer system comprises a logic system, and, operatively coupled to the logic system, a computer-memory system holding instructions that, when executed by the logic system, cause the computer system to: receive a token-behavior selection corresponding to a real-world asset to be tracked on a virtual ledger, the token behavior selection identifying a client-defined combination of behaviors; construct a template for registration of a token class on the virtual ledger according to the provider-defined architecture of the virtual ledger, wherein each new token instantiated from the token class exhibits the client-defined combination of behaviors as determined by the token-behavior selection; and provide access to the template to a client computer device.

US Patent Pub. No. 2020/0089672 for Multi-Tenant Distributed Ledger Interfaces by inventors Velisetti et al., filed Dec. 20, 2018 and published Mar. 19, 2020, is directed to a set of interfaces is described for implementing a blockchain network by a multi-tenant server, wherein the set of interfaces comprise an object mapping interface. The object mapping interface includes a set object function to designate a tenant object for use in the blockchain network based on an input object; a map function to map fields of the tenant object in a multi-tenant system managed by the multi-tenant server and fields of an exchange object used by the blockchain network based on an input set of field mappings; and a set owner function to set a tenant in the multi-tenant system as an owner of the mappings based on an input identifier.

US Patent Pub. No. 2019/0080404 for System and method of providing a timing feature to token offerings by inventor Molinari et al., filed Sep. 10, 2018 and published Mar. 14, 2019, is directed to a method for generating a unique token associated with a profit participation parameter in an issuing entity for a token holder, the unique token being generated as a security according to a security regulation and being based on a determination of demand by token holders. The method includes implementing a smart contract on a blockchain to manage distributions from the issuing entity to the token holder according to the unique token, wherein the smart contract comprises a set of promises in digital form and comprises defined protocols for managing value distribution from the issuing entity to the token holder, and wherein one of the unique token and the smart contract comprises a timeframe associated with a restriction on selling the unique token, implementing a restriction on a sale of the unique token during the timeframe and enabling the sale of the unique token after the timeframe.

US Patent Pub. No. 2014/0129457 for An interactive organizational decision-making and compliance facilitation portal by inventor Peeler, filed Nov. 1, 2013 and published May 8, 2014, is directed to systems and methods for facilitation of enterprise compliance with managed rules or policies, including the use of and interactive compliance application including a decision tree structure with decision nodes, wherein an enterprise user may answer one or more specific questions and compliance guidance with respect to one or more managed rules or policies is provided according to received answers to the questions. An interactive decision facilitation portal enables the decision tree structure, by enabling both computer-algorithm-implemented decision nodes and human-aided decision nodes of the decision tree structure.

### SUMMARY OF THE INVENTION

The present invention relates to a system for managing data relating to tokenized assets. The systems, methods, and storage media disclosed herein are operable to create and manage tokenized assets, wherein the tokenized asset is operable to be a tokenized fund containing other tokenized assets. Further, the system of the present invention implements a waterfall payment structure to manage the tokenized funds while assessing the valuation of the asset in real-time.

It is an object of this invention to provide a system for increased flexibility and transparency of tokenized fund management, where token owners and investors are able to view the digital history of the tokens. Further, the system of the present invention seeks to provide increased oversight of fund operations while decreasing the cost of asset management.

In one embodiment, the present invention is a system for storage and management of tokenized assets including at least one user device, a decentralized computer platform including at least one module, a distributed ledger, and a server including a database, wherein the decentralized computer platform is stored on the database of the server, wherein the at least one user device is in network communication with the at least one server, wherein the at least one user device is operable to access the decentralized computer platform, wherein the decentralized computer network is implemented by the distributed ledger, wherein the decentralized computer platform is operable to issue a unique token identifier associated with an asset to create an asset token, wherein the asset token is assigned a class, wherein the class includes at least one property and/or at least one function, wherein the assignment of the class enables the asset token to expose, display, and/or execute the at least one property and/or the at least one function specific to the class, and wherein the decentralized computer platform executes at least one internal waterfall logic to process income generated by the asset token.

In another embodiment, the present invention is a system for storage and management of tokenized assets including, at least one user device, a decentralized computer platform including at least one module, a distributed ledger, and a server including a database, wherein the decentralized computer platform is stored on the database of the server, wherein the at least one user device is in network communication with the at least one server, wherein the at least one user device is operable to access the decentralized computer platform, wherein the decentralized computer network is implemented by the distributed ledger, wherein the decentralized computer platform is operable to issue a first unique token identifier associated with an asset to create an asset token, wherein the asset token is assigned a class, wherein the assignment of the class enables the asset token to expose, display, and/or execute at least one property and/or at least one function specific to the class, wherein the decentralized computer platform is further operable to issue a second unique token identifier, wherein the second unique token identifier is operable to be associated with the at least one asset token to create a composite token, wherein the decentralized computer platform is operable to add at least one additional asset token to the composite token, wherein the composite token is operable to remove the at least one asset token and/or the at least one additional asset token from the composite token, and wherein the decentralized computer platform executes at least one internal waterfall logic to process income generated by the asset token and/or the at least one additional asset token.

In yet another embodiment, the present invention is a method of processing income generated by tokenized assets including, issuing an asset token on a decentralized platform, the steps including, issuing a unique token identifier associated with an asset, wherein the unique token identifier is associated with the asset, assigning an asset class to the asset token and associating a set of properties and/or functions with the asset token based on properties and/or functions of the assigned asset class, and associating a wallet with the asset token, adding at least one additional asset token to the wallet associated with the asset token to create a composite token, publishing the unique token identifier to a distributed ledger which implements the decentralized computer platform, determining a value of the composite token in real-time, creating an internal waterfall logic by linking a series of at least two smart contracts, wherein deployment of a first smart contract of the series of smart contracts initiates deployment of a second smart contract of the series of smart contracts, and applying the internal waterfall logic to the composite token, wherein deployment of a first smart contract is initiated by a calculated increase in the value of the composite token.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow chart of a method for configuring a computing platform to process a fund structure according to one embodiment of the present invention.

FIG. 2 is a schematic diagram of a computing architecture for creating, configuring, and managing tokenized assets according to one embodiment of the present invention.

FIG. 3 is a schematic illustration of a basic non-fungible asset token and associated interfaces according to one embodiment of the present invention.

FIG. 4 illustrates the process flow of asset token sales and purchases according to one embodiment of the present invention

FIG. 5 illustrates the interface specifications for asset valuation functions according to one embodiment of the present invention.

FIG. 6 illustrates the flow of a valuation process according to one embodiment of the present invention.

FIG. 7 is a schematic illustration of the basic fund token and its high level interfaces according to one embodiment of the present invention.

FIG. 8 is a schematic diagram illustrating examples of token wallets owning other tokens according to one embodiment of the present invention.

FIG. 9 is a schematic illustration of a connection of a non-fungible asset to a fungible asset token to support fractional ownership is a schematic illustration of the basic non-fungible asset token according to one embodiment of the present invention.

FIG. 10 illustrates basic fund operations than can be automated using a decoupled asset management logic and a fund structure according to one embodiment of the present invention.

FIG. 11 is a schematic diagram of a system of the present invention.

### DETAILED DESCRIPTION

The present invention is generally directed to a system and for the communication of valuation and diligence data, management of complex and dissimilar assets, and aggregation of multiple tokenized assets into a composite token. The systems, methods, and storage media disclosed herein are operable to create and manage tokenized assets, wherein the tokenized asset is operable to be a tokenized fund containing other tokenized assets. Further, the system of the present invention implements a waterfall payment structure to manage the tokenized funds while assessing the valuation of the asset in real-time.

In one embodiment, the present invention is a system for storage and management of tokenized assets including at least one user device, a decentralized computer platform including at least one module, a distributed ledger, and a server including a database, wherein the decentralized computer platform is stored on the database of the server, wherein the at least one user device is in network communication with the at least one server, wherein the at least one user device is operable to access the decentralized computer platform, wherein the decentralized computer network is implemented by the distributed ledger, wherein the decentralized computer platform is operable to issue a unique token identifier associated with an asset to create an asset token, wherein the asset token is assigned a class, wherein the class includes at least one property and/or at least one function, wherein the assignment of the class enables the asset token to expose, display, and/or execute the at least one property and/or the at least one function specific to the class, and wherein the decentralized computer platform executes at least one internal waterfall logic to process income generated by the asset token.

In another embodiment, the present invention is a system for storage and management of tokenized assets including, at least one user device, a decentralized computer platform including at least one module, a distributed ledger, and a server including a database, wherein the decentralized computer platform is stored on the database of the server, wherein the at least one user device is in network communication with the at least one server, wherein the at least one user device is operable to access the decentralized computer platform, wherein the decentralized computer network is implemented by the distributed ledger, wherein the decentralized computer platform is operable to issue a first unique token identifier associated with an asset to create an asset token, wherein the asset token is assigned a class, wherein the assignment of the class enables the asset token to expose, display, and/or execute at least one property and/or at least one function specific to the class, wherein the decentralized computer platform is further operable to issue a second unique token identifier, wherein the second unique token identifier is operable to be associated with the at least one asset token to create a composite token, wherein the decentralized computer platform is operable to add at least one additional asset token to the composite token, wherein the composite token is operable to remove the at least one asset token and/or the at least one additional asset token from the composite token, and wherein the decentralized computer platform executes at least one internal waterfall logic to process income generated by the asset token and/or the at least one additional asset token.

In yet another embodiment, the present invention is a method of processing income generated by tokenized assets including, issuing an asset token on a decentralized platform, the steps including, issuing a unique token identifier associated with an asset, wherein the unique token identifier is associated with the asset, assigning an asset class to the asset token and associating a set of properties and/or functions with the asset token based on properties and/or functions of the assigned asset class, and associating a wallet with the asset token, adding at least one additional asset token to the wallet associated with the asset token to create a composite token, publishing the unique token identifier to a distributed ledger which implements the decentralized computer platform, determining a value of the composite token in real-time, creating an internal waterfall logic by linking a series of at least two smart contracts, wherein deployment of a first smart contract of the series of smart contracts initiates deployment of a second smart contract of the series of smart contracts, and applying the internal waterfall logic to the composite token, wherein deployment of a first smart contract is initiated by a calculated increase in the value of the composite token.

None of the prior art discloses the implementation of waterfall processing logic for managing income generated by assets within a fund. Further, none of the prior art discloses the ability to implement specialized waterfall logic using plug-in points built into the decentralized network. Further still, none of the prior art discloses the valuation and subsequent publication of composite tokens containing heterogenous assets.

Some prior art systems seek to apply Distributed Ledger Technologies (DLT), such as blockchain, to various financial transactions to increase transparency. However, current data models and architectures do not provide a common model for the communication of valuation and other diligence data and mechanisms for combination and management of complex and dissimilar assets, such as derivatives and derivative funds, in a flexible manner. Specifically, none of the prior art discloses a distributed architecture for real time valuation of tokens corresponding to funds containing heterogenous assets. Additionally, none of the prior art discloses plug-in points wherein developers are able to create and implement personalized fund management strategies for distribution of income from fund assets.

In finance, a derivative is an asset for which value is derived from the performance of an underlying entity. This underlying entity is operable to be an asset, index, or income stream, and is often simply called the “underlying”. Derivatives are used to provide access to otherwise hard-to-trade assets or markets. One type of derivatives is a Residential Mortgage Backed Security (RMBS) which are often aggregated into funds or Exchange Traded Products (ETP). An RMBS fund is an investment similar to a bond that is made up of a bundle of home loans purchased from the banks that issued them. Investors in RMBS funds receive periodic payments similar to bond coupon payments. Also, other derivatives, such as futures and forward contracts, swaps, and options are often aggregated into funds.

Most economists agree that the root cause of the 2008 Global Financial Crisis (GFC) was the eroded performance of RMBS funds. While asset underperformance in markets is common, the lack of effective pricing and transparency in the performance of the RMBS fund assets over time resulted in a toxic spread of risk across the financial system due at least partially to inadequacies of computing platforms supporting the financial systems. When the extent of the risk was eventually understood by the markets, it resulted in a ripple effect as market liquidity evaporated in the face of balance sheet uncertainty. Markets froze, stalwart institutions fell, and, without the aggressive intervention of global governments at a substantial cost to taxpayers, it is likely that the entire financial ecosystem may have collapsed resulting in a global depression. Thus, there is a need for a system capable of evaluating asset performance in real time while providing pricing transparency to users of the system. The system must be further operable to provide transparency and valuation for funds in addition to individual assets. Further still, the system must be operable to support flexible and highly personalized strategies for management of funds generated by in order to accommodate the

Existing prior art systems employ widely varying architectures operated by parties with different levels of sophistication. This obfuscates the collection of data necessary for tracking and conducting valuation on the underlying assets of tokens. Further, the aggregation of these assets into funds and the fractionalization of funds into shares, when combined with the dynamics of market conditions, makes it difficult, if not impossible for existing systems to adequately communicate valuation in real time to market participants and other stakeholders. For example, in the case of an RMBS fund of thousands of mortgage backed securities, valuation is dependent on current interest rates, the creditworthiness of each homeowner/mortgagee, the payment status of each mortgage, housing valuations in each region and many other dynamic conditions that are specific to each individual mortgage of the thousands of mortgages. The present invention advantageously provides a way to gather all of this information and process the same for valuation in a real-time manner, thus allowing for effective pricing and transparency for assets and funds.

The present invention includes a data model and computer architecture that streamlines and decentralizes asset management while providing improved data processing for valuation, transparency, and other functions. Embodiments herein include methods executed by at least one computing device on a distributed ledger over a wireless network using a smart contract to issue cryptographic tokens representing assets. Embodiments herein include a novel data structure and interface designed to enable token nesting, that is, tokens as assets that contain other tokens as assets. Since investment funds are assets that contain assets, this novel data model provides a processing backbone on which advanced fund strategies, valuations and asset management may be performed in a decentralized manner.

In one embodiment, the system of the present invention includes centralized architectures. In one embodiment, the system of the present invention provides data processing and communication advantages with respect to these centralized architectures. Additionally, the novel token data structure and interface design advantageously enable shared transaction logic, comprehensive auditability and scalable record keeping, while decoupling individual asset behavior and associated logic. That is, the structure permits reuse of basic transaction logic and asset management functions.

Embodiments disclosed herein support a wide variety of asset types, permit the formation of simple fund structures with homogeneous assets as well as complex, diversified funds with heterogeneous assets, and exposes plug-in points that facilitate rapid innovation in novel fund management approaches. One of ordinary skill in the art will appreciate that the term “plug-in” point as used herein is used to describe a location within the architecture wherein a developer is operable to insert a smart contract to execute a function without affecting the overall operability of the system. Specifically, developers are able to plug-in smart contracts with personalized fund management strategies and income waterfall processes.

The fund structures disclosed herein are advantageously creates a repeatable model to enhance investor transparency, reduce the cost of fund maintenance, and streamline the path to market for new asset classes and fund management strategies. According to one embodiment of the present invention, a party offering an asset management strategy, referred to herein as an Issuer, is operable to deploy a market ready asset on a decentralized networked computing platform in minutes including, if desired, complex and highly regulated instruments like Exchange Traded Funds (ETFs).

In one embodiment, the present invention provides a computer architecture, computer readable data structure, and computer interface to inspect, value, transact, combine, and manage any asset type including composite assets (e.g. funds). When coupled with a token transaction platform, such as that disclosed in US Patent Pub. No. 2019/0164151 incorporated herein by reference in its entirety, the model provides a fully functional decentralized architecture for global regulatory compliance, scalable transaction logic, simplified management, and transparent asset performance. The result is an automated, standards-based, self-reporting fund that can be leveraged by any Issuer to automatically execute the desired asset management strategy on behalf of investors on a decentralized platform.

In one embodiment, the present invention provides platform that includes a non-fungible token representing a fund shell, that is, a fund structure that handles general purpose fund management functions such as adding and removing assets or publishing valuation, may be populated with assets, and is operable to incorporate third party smart contracts, if desired, for waterfall processing of fund proceeds. The shell provides a plug-in structure so that fund management strategies are operable to be handled manually, through stakeholder voting, or via automated asset management strategies. The present invention advantageously enables rapid innovation in the development and deployment of automated (or manual) management strategies on a decentralized network by decoupling asset allocation logic from general purpose fund processing.

The applicant discloses a novel fund management strategy called “elastic securitization”. This strategy permits a closed end fund, (i.e., a fund in which there are a fixed number of shares) to expand or contract in size (assets under management) based on market demand without the use of authorized participants. This innovative approach is helpful to support exchange traded funds of illiquid assets and thereby provides investors access to new classes of assets via the multistep process for creation and management of a tokenized asset disclosed herein. As used herein, “investor” refers to the party investing value in the fungible digital token which they hold.

The present invention advantageously includes interface specifications necessary for linking tokenized assets to a fungible token transaction framework. The token transaction framework is then operable to extend conventional DLT practices for value transfer (e.g., Ethereum ERC20) with logic for corporate governance, payment distributions, and policy enforcement. The resulting data structure allows a decentralized architecture to automatically communicate value of tokens, funds and other complex assets. This provides investors with the ability to efficiently inspect the value that they own. Prior art systems are limited in the transparency available for complex fund structures with heterogeneous and nested assets (e.g., a fund of funds). The present invention provides an architecture that allows an investor, or other stakeholder, to review both overall performance and an enumerated list of the underlying assets with consistent and real-time access to the performance, cash flows, and data for each asset. The present invention further permits increased transparency in underlying asset performance, increased regulatory oversight of fund operations, and decreased cost of operations for asset managers. Thus, the present invention addresses the underlying causes of the Global Financial Crisis (GFC) of 2008 in order to prevent such an economic event from recurring.

Referring now to the drawings in general, the illustrations are for the purpose of describing one or more preferred embodiments of the invention and are not intended to limit the invention thereto.

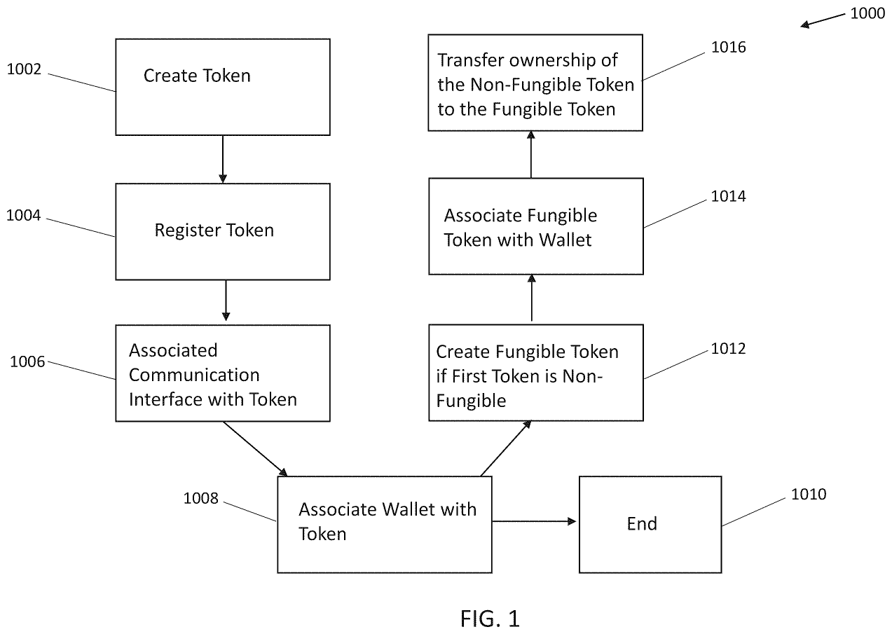

FIG. 1 illustrates a method 1000 for configuring a data storage and retrieval system for managing data relating to tokenized assets. At 1002 a digital token is created in accordance with a class definition, the token including a unique token identifier. The digital token is operable to correspond to a physical or digital asset, including but not limited to equities (including common stock, preferred stock, contributed surplus, additional paid-in capital, and treasury stock), bonds (including but not limited to treasury bonds, government-sponsored enterprise (GSE) bonds, investment-grade bonds, high-yield bonds, foreign bonds, mortgage-backed bonds and municipal bonds), real estate, precious metals, motor vehicles, antiques, intellectual property assets, tokens (including tokens issued using the system of the present invention and tokens generated by other systems), and copyright to original works of authorship including literary works, musical works, dramatic works, pantomimes, choreographic works, pictorial works, graphic works, sculptural works, sound recordings, computer programs, and architectural works. In one embodiment, the token identifier is a unique instance of a smart contract. In one embodiment, the token identifier is a unique string of characters and/or numbers that distinguish a first token from a second token. At 1004, the digital token is registered in association with an asset as a unique record in a memory database of an asset registry. At 1006, a communication interface is associated with the digital token in accordance with the class definition. The communication interface is compliant with a communication specification implemented by the asset registry, and which is configured to expose a set of predefined functions. The predefined functions are operable to include asset ownership transfer functions, asset valuation publication functions, asset attribute determination functions and asset specific processing logic.

At 1008, a cryptographic wallet is associated with the digital token. The wallet is configured to conduct token functions that are recorded in the asset registry. For a fungible token, the process is operable to end 1010 after association with a wallet. If the digital token is non-fungible, a fungible digital token is created at 1012. At 1014, a cryptographic wallet is associated with the fungible digital token. The wallet is configured to conduct token functions. At 1016 ownership of the non-fungible digital token is transferred to the fungible digital token in order to wrap the non-fungible digital token with the fungible digital token and thereby enable fractional ownership of the asset represented by the non-fungible token including functions associated with shared ownership such as multi-party dividend distributions, corporate governance, and share trading.

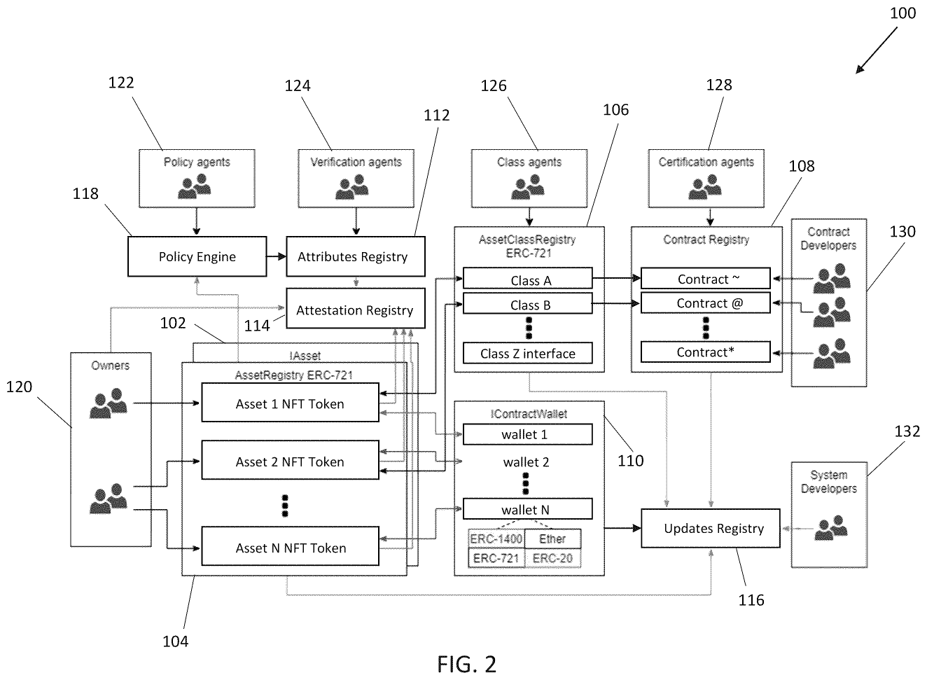

In one embodiment, method 1000 is implemented by one or more user devices. The one or more user devices include one or more devices executing some or all of the operations of method 1000 in response to instructions stored electronically on an electronic storage medium. The one or more user devices include one or more devices configured through hardware, firmware, and/or software to be specifically designed for execution of one or more of the operations of method 1000. For example, method 1000 is operable to be implemented by the architecture of FIG. 2. In one embodiment, the method 1000 is implemented by a decentralized system, such as a distributed ledger, by a centralized system, or by a combination of the two types of systems. In one embodiment, the present invention is implemented on a distributed ledger. In one embodiment, the present invention is implemented on the Ethereum distributed ledger.

The disclosed embodiments improve data management and transmission in a manner that advantageously improves access to capital markets using Distributed Ledger Technologies (DLT) to create assets with comprehensive, built-in transparency and immutability, while facilitating efficient transactions. The embodiments provide a systematic and scalable framework to apply these benefits to fund management for any asset class providing issuers an easy path to market with innovative strategies.

FIG. 2 illustrates a computer architecture 100 for tokenizing and managing assets according to one embodiment of the present invention. The computer architecture of the system of the present invention is operable to include one or more computing platforms that may be configured to communicate with one or more remote computing platforms according to a client/server architecture, peer-to-peer architecture and/or other communication distribution architectures. The platforms may be configured by machine-readable instructions which may include one or more instruction modules. The instruction modules are operable to include computer program modules stored in non-transient memory.

In one embodiment of the system of the present invention, an issuer is operable create and launch a tokenized asset (e.g., an ETF) via a multistep process including: (1) tokenizing fund assets using the IAssetToken Specification of the IAsset module 102 (described in detail below); (2) tokenizing the fund itself using the IAssetFund specification of the IAsset module 102 (described in detail below); (3) using a novel token data structure enabling asset management, enumeration, and nesting to attach tokenized assets to the fund using an AddAssetRequest function (described in detail below); and (4), if desired, attach a non-fungible token to a fungible token using an IAssetManagementFungible interface of IAsset module 102 (described in detail below) to support fractional ownership and simplified transactions. “Fractional ownership” refers to the situation in which a fungible asset is subdivided so there is more than one owner of an asset. The resulting tokens are referred to herein as “tokens” or “IAsset tokens.” An investment fund (i.e., ETF), is used herein as an example of an asset that is operable to be managed via the system of the present invention. However, one of ordinary skill in the art will appreciate that the system of the present invention is operable to manage a variety of fund types and assets. All of these specifications, interfaces, process steps and data structures facilitate fund management in decentralized systems and are described in detail herein. Examples of source code implementing the various functions and interfaces is included in the Appendix which is a part of the specification of this patent application.

The Asset Registry module 104 includes a smart contract, AssetRegistry, that issues and tracks tokens representing assets. These tokens implement interfaces to manage relationships between assets and expose basic asset functions, such as valuation functions. One of ordinary skill in the art will appreciate the use of “interface” herein refers to section of a smart contract containing a description of all functions that an object must have for it to initiate the smart contract. Assets are operable to be assigned a class that is tracked in the Asset Class Registry module 106. The Asset Class Registry Module 106 includes a smart contract, AssetClassRegistry, that assigns a class to an asset. The term “class” as used herein refers to a particular data structure for creating objects, providing initial values for state, and implementing behaviors. Thus, an asset class definition contains the methods and variables specific to the specific type of asset, including member variables or attributes and member functions or methods. An asset class assignment advantageously enables the token to expose, display, and/or execute the properties and functions specific to that class.

Contract Registry module 108 stores smart contract interfaces that provide customized functions for an AssetClass (from Asset Class Registry module 106) or Asset instance (from Asset Registry module 104). Each token is operable to be assigned a class which provides access to the attributes, functions and implementation logic of the class. The Asset or AssetClass owner (or designee) is able to select an implementation from the interface registry. As used herein, “owner” refers to a party in possession of the tokenized asset. Contract Developers module 130 is operable to receive submissions of new smart contracts with custom implementations and store the new smart contracts to Contract Registry module 108 for owners to select in order to expose the custom logic for their asset. Contract Registry module 108 further enables developers to publish new interfaces and implementations to enhance or extend the behavior of all assets in a class. The I Contract Wallet module 110 implements and manages smart contract-based cryptographic wallets that are operable to be attached to individual tokens representing assets, classes, or other elements providing wallet functionality via that asset.

A smart contract is operable to be deployed on a distributed ledger that implements Asset Registry module 104 to enable issuance of non-fungible tokens representing individual assets. One of ordinary skill in the art will appreciate the techniques and components necessitated by the physical deployment of the smart contract implementing Asset Registry module 104. On issuance of a token, an AssetRegistry smart contract of Asset Registry module 104 assigns an asset class to the token and deploys a new smart contract implementing the IContractWallet interface to thereby associate a wallet with the token. As a result, each created token will have a unique wallet address (as shown in FIG. 2) linked to the token by the token identifier and is operable to implement properties and functions of an assigned asset class. Asset Registry module 104 operates the IContractWallet interface and enforces policy for actions regarding the wallet. In one embodiment, the enforced policy will only allow the owner of the token to execute actions via the wallet contract.

The wallet will support functionality for transfer or receipt of tokens and, optionally, cryptocurrency such as Ether (ETH). Wallets are operable to support tokens compatible with standard interface tokens, including but not limited to ERC-20, ERC-721, and ERC-1400.

The smart contracts implemented by I Contract Wallet module 110 operates wallets and will support upgradability via Updates Registry module 116. In one embodiment, each system component described herein is operable to receive updated information via Updates Registry module 116. This structure allows registration of new wallet smart contracts implementing changed or upgraded behavior. The token owner, or other designee, may choose to assign a new wallet contract to the token to implement the upgraded functions or may reject such an assignment in some cases.

The token owners module 120 is associated with systems of a party or parties who exercise control over assets (e.g., exchange traded funds and/or non-fungible tokens) in the Asset Registry module 104. A party or parties who exercise control over assets is referred to herein as a token owner. A token owner is operable to control the assets directly via smart contract-based cryptographic wallets or indirectly via the tokens that have control authority over the asset.

Policy agents module 122 is associated with systems of a party or parties with the authority to publish policy that govern token behavior. A party or parties with the authority to publish policy that govern token behavior is referred to herein as a policy agent. The policy engine module 118 receives data including the policy from policy agents module 122. After the policy is sent to the policy engine, it is accessible via other modules of the system (i.e., token owners) and is considered published. In one embodiment, the token owner is operable to designate a policy published by a policy agent to govern specific actions performed on or through the token. Details on such policies used to create compliance aware tokens are found in U.S. Pat. No. 11,410,235, incorporated herein by reference in its entirety.

Verification agents module 124 is associated with systems of a party or parties that create attributes (i.e., data point characteristics or behavioral functions) of objects in the system. A party or parties that create attributes of objects in the system is referred to herein as verification agents. A verification agent has the ability to attest to attribute values associated with objects. For example, a legal firm are operable to serve as the verification agent and verify that a fund asset is a 1940 Act fund for the purposes of regulatory policy enforcement. This attribute is then stored in the Attribute Registry module 112 as an attribute of the token. The Attestation Registry module 114 stores the attributes of a token which execute behavioral functions which have been verified by a verification agent for the purposes of regulatory policy enforcement. Details on the Attestation Registry and Attribute Registry are be found in US Patent Pub. No. 2022/0188810, incorporated herein by reference in its entirety.

Class agents modules 126 are associated with systems of a party or parties who exercise control over all tokens within an asset class. A party or parties who exercise control over all tokens within an asset class are referred to herein as class agents. Class agents have the ability to select attributes and interfaces and apply the selected attributes and interfaces to all asset tokens are associated with a class.

Contract Developer modules 130 are associated with systems of a party or parties that develop smart contract code to be used by tokens to perform functions associated with an asset class. A party or parties that develop smart contract code to be used by tokens according to the system of the present invention are referred to herein as contract developers. These smart contract codes are operable to be added, upgraded, or removed by a class agent.

Certification Agent modules 128 are associated with systems of a party or parties who certify that smart contract code published by the contract developers performs the function as described, are secure, and are free from defect. A party or parties who certify the smart contract code published by the contract developers are referred to herein as certification agents. In one embodiment, smart contract codes developed by contract developers must be certified by a certification agent before being added, upgraded, or removed by a class agent.

System Developer modules 132 are associated with systems of a party or parties authorized to publish updates to core elements of the system such as the Asset Registry module 104 or the I Contract Wallet module 110. A party or parties authorized to publish updates to core elements of the system is referred to herein as a system developer.

It should be appreciated that the modules illustrated in FIG. 2 are operable to be implemented within a single processing unit or multiple processing units, one or more of the modules are operable to be implemented remotely from the other modules, such as on a plurality of client devices in a distribution architecture. The description of the functionality provided by the different modules is for illustrative purposes, and is not intended to be limiting, as any of the modules may provide more or less functionality than is described. In one embodiment, one or more of modules is eliminated, and some or all of the functionality of the module as described herein is provided by one or more other modules. For example, the class agent module is removed from the system of the present invention, and the function of the class agent module is operable to be performed by the certification agent module.

FIG. 2 is a schematic representation of a token data record 200 according to one embodiment of the present invention. The token data record 200 defines the non-fungible token. The Asset Registry module 104 is operable to implement a standard interface (e.g., the Ethereum Request for Comment (ERC 721) standard interface) to enable the issuance of non-fungible tokens. Additionally, Asset Registry module 104 implements the novel interfaces described herein that facilitate functions for asset management in decentralized environments such as distributed ledgers, such as asset valuation functions 202, ownership transfer functions 204, and data management functions 206. These interfaces and associated data structures permit the creation of composite tokens (i.e., tokens that contain or are linked to other tokens) in a structure. In one embodiment, the structure is recursive. This novel structure of composite tokens is described in greater detail below and permits implementation of a fund (i.e., a composite asset that contains other assets) over a decentralized computer architecture.

For the purpose of example and not limitation, the token data record depicted in FIG. 2 is enabled by the ERC-721 standard interface. Consistent with the ERC-721 standard interface, Asset Registry module 104 facilitates the issuance of non-fungible tokens, with each token representing a unique asset. For each issued token, Asset Registry module 104 records and stores data 208 including but not limited to the unique identifier for the token; the asset class from Asset Class Registry module 106; the asset name and description; and the address of the token's wallet 210 (described below). The token is further operable to be assigned additional attributes and values according to the methods and systems of U.S. Pat. No. 11,410,235, incorporated herein by reference in its entirety.

In one embodiment, the digital tokens implement the IAsset interface of IAsset module 102, exposing a set of functions including but not limited to asset valuation function 202, ownership transfer function 204, and data management function 206. The exposed functions facilitate asset management over a decentralized computing platform in the manner described below. Using data structure 200, any asset of value is operable to be issued as a unique record on a distributed ledger reflecting the asset's ownership (i.e., “tokenized”) and coupled with supporting essential asset management functions needed to support scalable operations, such as fund operations. As described in detail below, the IAsset interface of the IAsset module 102 supports specific functions that enable an asset to present consistent data and valuation information, participate in funds and other asset management structures, implement asset specific logic, and/or encapsulate other tokens representing value instruments that are not created with native asset management capabilities.

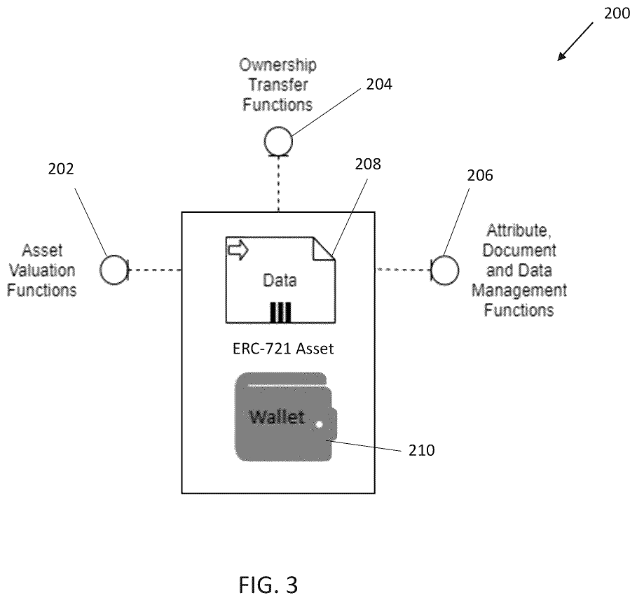

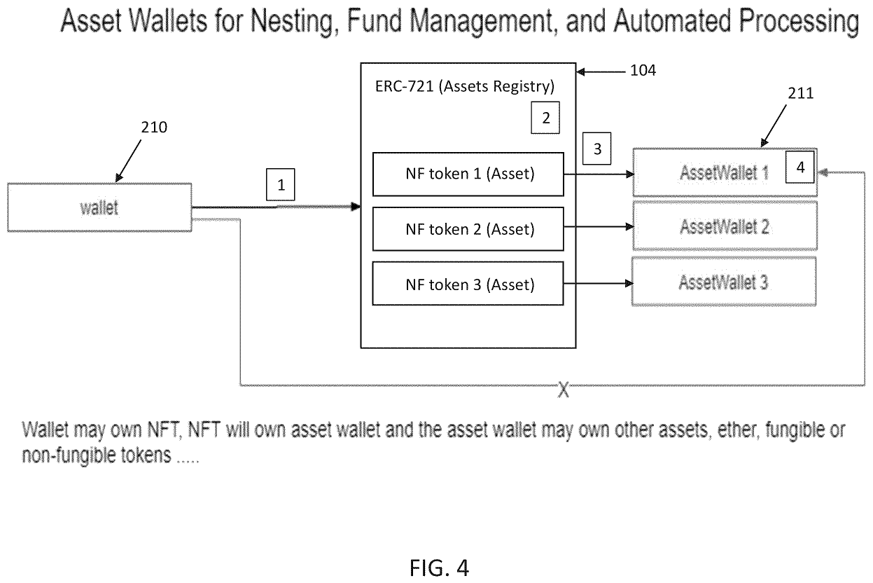

As noted above and shown in FIGS. 3 and 4, a token 200 is associated with a cryptographic wallet 210. In one embodiment, the system of the present invention includes an interface specification and data structure enabling a smart contract and/or a discrete token to be associated with (i.e., to own) a cryptographic wallet. This novel structure enables a token to own other tokens, add or remove other tokens from association with the token, and conduct transactions with other entities by interacting with wallets 211 corresponding to other tokens or entities. A token that owns a corresponding wallet containing other tokens, thereby representing a token-in-token structure, is referred to as a “composite token” herein. The cryptographic wallet 210 is operable to interact with the wallets 211 through the Asset Registry module 104.

Non-fungible tokens in the Asset Registry are assigned a wallet 210 on issuance by the Asset Registry module 104 by implementing the IAssetRegistry. IssueAsset function using an IassetWalletFactory interface (see Appendix for code example). This interface issues a smart contract implementing an IcontractWallet interface which is stored in Contract Registry module 108 in association with the unique token ID. An example of code implementing this interface is found in the Appendix.

The interfaces of the wallet contract are operable to be executed using the IassetWallet wrapper, that is, the set of functions conforming to the IassetWallet interface specification published in the appendix that are available via the AssetRegistry smart contract for use by the owner of the Iasset token or other permission structures as implemented in the smart contract logic. If the signer is not authorized to execute the function as designated by Asset Registry module 104, implemented as smart contract logic for example, the proposed operation (e.g., “send tokens”) will not be permitted and thus will not occur. The IAssetWallet exposes an associated wallet address via a GetWallet function of the attached code. This address is operable to be used as an origin or destination for transactions in the same way as any wallet on the distributed ledger.

Linking a wallet to a token in this structure advantageously enables full traceability of the actions performed on behalf of the asset corresponding to the token, the ability to automate actions through an asset management smart contract that trades based on a strategy, the ability to conduct transactions with an asset's wallet as if transacting with an entity, and the ability to insert robust policies into asset operations including operations via the asset wallet.

As shown in FIG. 4, the “token-in-token” structure, in which cryptographic wallet 210 corresponding to tokens is operable to own other tokens and/or associate with the wallets 211 corresponding to other tokens, enabling the creation of tokenized composite assets (i.e., an asset that contains other assets). One type of composite asset is a fund. Thus, the present invention is advantageous in the management of funds as the system of the present invention enables assets to associate with additional assets within a single wallet. When issued as an IAsset token supporting the IAssetManagement interfaces, the token supports asset management transactions enabling the execution of a fund management strategy manually by a fund manager or automatically via a smart contract based algorithm on a distributed ledger. Using this model, composite assets are operable to be tokenized and contain, add, or remove assets like cryptocurrencies, other asset tokens (simple or composite), or tokenized shares of assets.

In one embodiment, the token-in-token structure is used to “wrap” third party tokens that do not support asset management with the IAsset token interface, to be managed in fund structures as individual assets. Wrapping a third party token is accomplished by transferring the third party token to the IAsset token's wallet. This will allow any third party token or smart contract to be wrapped and processed as an asset exposing a consistent structure for automated asset management and fund operation. With these technical elements in place, it is possible to quickly launch complex self-processing funds. For example, in an ETF structure, one or more non-fungible tokens representing individual assets are issued via the Asset Registry module 104 using the IAssetRegistry. IssueAsset function (see example code in Appendix). Each token implements the IAsset interface which extends the basic ERC 721 specification with ownership transfer functions implemented via the IAssetTransferable interfaces to support asset management, enhance transparency, and support purchase and sale of the asset in a marketplace.

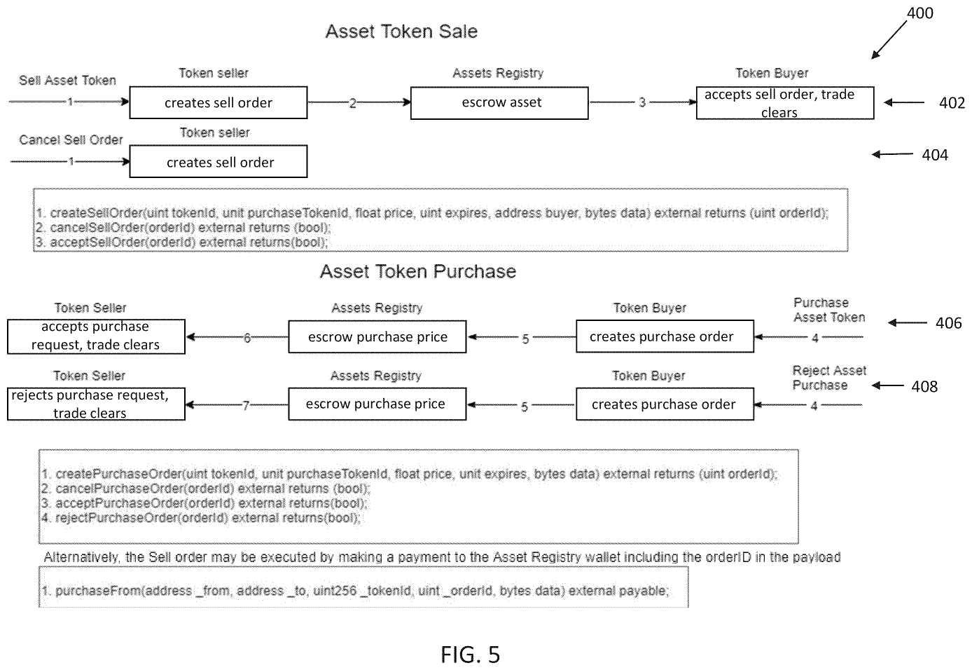

FIG. 5 schematically illustrates process flows 400 of asset ownerships transfer functions (shown as 204 in FIG. 2). As noted above, tokens are operable to implement the ERC 721 standard interfaces, which include conventional ownership and transfer functions defined in the ERC 721 specification. The tokens are then operable to implement a compliance aware token transaction framework. The present invention advantageously improves this framework with functions to enable systematic asset purchase, sale and linking.

As shown at 402 in FIG. 5, a sell order for a token is created with the createSellOrder function that operates on a data structure. The sell order includes the identifying variables for a specific asset in order to create a sell order associated with the specific asset. In one embodiment, the createSellOrder function includes parameters uint tokenid, unit purchase Tokenid, float price, uint expires, address buyer, and bytes data. The present invention then generates an external return of uint orderId. A cancel SellOrder function operates on the order id and returns a Boolean true or false value. If the cancelSellOrder function returns FALSE, the token buyer accepts the sell order and an acceptSellOrder function is executed. As shown at 404, if the cancelSellOrder function returns TRUE (i.e., the sell order has been cancelled) the order process is terminated. In one embodiment, if the cancelSellOrder function returns FALSE (i.e., the sell order has been cancelled) the order process is terminated.

For a token purchase, as shown at 406, a createPurchaseOrder function is executed on a data structure. The purchase order includes the identifying variables for a specific asset in order to create a purchase order associated with the specific asset. In one embodiment, the createPurchaseOrder function includes parameters uint tokenid, unit purchaseTokenid, float price, uint expires, and bytes data. The createPurchaseOrder function returns the order identification as an order ID in the form of (uint orderid). A cancelPurchaseOrder function is executed on the parameter (orderid) and returns a Boolean. If the return is FALSE, the acceptPurchaseOrder function is executed on the parameter (orderid) and returns a Boolean. If the return is TRUE, the purchase is cleared and accepted. Alternatively, as shown at 408, the rejectPurchaseOrder function is executed on the parameter (orderid) and returns a Boolean. If the return is TRUE, the purchase is rejected. In one embodiment, the sell order is executed by making a payment to the Asset Registry wallet. The payment includes the orderID in the payload by executing the purchaseFrom function on a data structure, wherein the purchaseFrom function includes attributes values for address_from, address_to, uint256_tokenId, uint_orderId, and bytes data.

As noted above, transactions between tokens are accomplished by virtue of the wallets associated with the respective tokens. A token's wallet address is operable to be obtained via the IAssetWallet.GetWallet interface which is operable to be implemented by executing the code in the Appendix. In one embodiment, distribution logic is initiated internally by the asset. In one embodiment, distribution logic is initiated externally using the interface. In one embodiment, distribution logic is initiated both internally by the asset and externally using the interface.

An important aspect of transparency in financial markets is the ability of investors and prospective investors to view metadata, documents, and supporting data feeds for an asset. This information provides investors the means to develop their own opinion of a fair market price as well as providing a mechanism to assess the performance of intermediaries, like the asset manager, tasked with the responsibility to assess price in the market. Conventionally, such information has to be collated in a static manner and thus time-based reporting of the data is not pragmatic in prior art systems. In one embodiment, the present invention includes a comprehensive data structure for asset due diligence to provide scalable transparency. The scalable transparency provided by the system of the present invention is therefore advantageous over the complex tokenized assets of the prior art.

Transparency requires the ability to create, maintain, and inspect asset properties or attributes. Since asset types vary widely, it follows that asset attributes vary even more broadly. To support data analysis across a broad range of assets, a consistent framework is required to manage any property of any asset as attested by any authorized party. In one embodiment, the basic asset property management mechanism is ERC 1616, available at https://eips.ethereum.org/EIPS/eip-1616, last accessed Mar. 6, 2023 and incorporated herein by reference in its entirety. The present invention is operable to extend this asset property management via a token transaction to include scalable trust attestations and policy enforcement based on these attributes.

Additionally, asset due diligence often requires document and data management. Distributed ledgers provide specific advantages for document management, including the provision of immutable records to support documentation and data as well as enabling access to a token transaction framework to view this data. In one embodiment, the present invention includes the Document Management ERC 1643, available at https://github.com/ethereum/EIPs/issues/1643, last accessed Mar. 6, 2023 and incorporated by reference in its entirety. The present invention also includes a mechanism to tokenize supporting datasets via a non-fungible token that describes the schema and other characteristics of supporting data using a non-fungible token. This specification supports advanced data authorization techniques, including the use of authorization tokens to provide distribution control and auditing of sensitive data. Policy-based data access and management are achieved using techniques of a decentralized access control taught by US Published Patent Application No. 2019/0164151, incorporated herein by reference in its entirety.

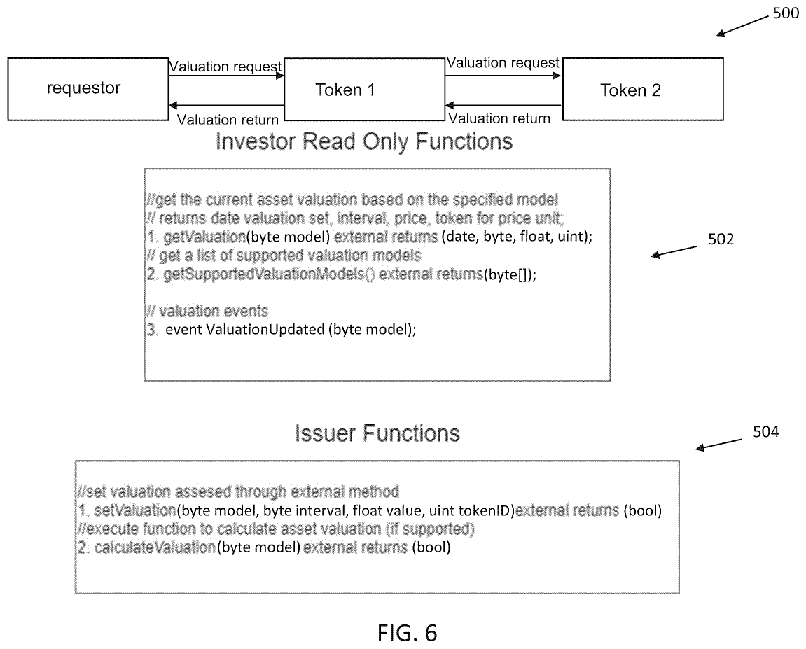

One the most important fiduciary responsibilities of an asset manager is to assess and publish the valuation of the managed asset. This provides investors a record of the understood value from the perspective of the asset manager based on the information available to the asset manager which, for most assets, exceeds the information that can be obtained by the investor at the time of the assessment. Thus, the system of the present invention advantageously allows for a more accurate understanding of the value of a tokenized asset in comparison to systems that do not utilize an asset manager in combination with asset valuation functions. FIG. 6 illustrates an example of a process flow 500, and related data structures, for asset valuation functions of an asset according to one embodiment of the present invention. These functions provide a consistent mechanism for publication and access to asset valuations. A common interface for valuation simplifies the integration of analysis tools. It also facilitates valuation of dissimilar assets, thus facilitating the formation of diversified funds. This is advantageous over the prior art, which is limited in the type of assets operable to be tokenized and thus represented in the funds stored on the distributed ledger. As noted above, asset tokens expose valuation interfaces to enable investors to see current assessments of the asset's value. A range of known accounting techniques are operable be used to assess asset value. The technique used for asset value assessment will be specified in the valueType attribute field for the asset. Asset tokens are operable to include internal logic to support the value assessments. The Asset Valuation function is operable to be implemented by executing the code example in the Appendix.

As shown in FIG. 6, a get Valuation request is sent to a token 1 and a valuation of token 1 will be returned by token 1. The request includes the valuation model to be applied. In one embodiment, a getSupportedValuationModels request is made to ascertain which valuation models are supported by token 1. In one embodiment, the logic to generate asset valuation varies across implementations and asset classes. In one embodiment, the logic to generate asset valuation is dependent upon an input asset type. In one embodiment, the logic to generate asset valuation dependent upon the specific needs of the issuer implementing the smart contract. The system of the present invention is therefore operable to store multiple valueType attributes. In one embodiment, each asset class includes an associated valueType attribute.

In one embodiment, valuations are operable to be published as attestations. As used herein, an attestation is an attribute value assigned with full attribution by a validated party, the asset owner, the asset manager, or other authorized parties. In one embodiment, the valuation data is generated by smart contract code in the Asset Registry module 104 or as assigned to the class in the Asset Class Registry module 106. This logic is operable to use real time attributes of the asset to assess value, “oracles” to reach external sources of data such as exchange pricing, or other sources for value assessment. For example, a par of a loan the outstanding principal of a loan. For an asset token representing a loan, the par valuation is included as an attribute of the loan token, found in the Attributes Registry module 112. As repayments are processed by the loan, the value assigned to the par attribute is changed by the loan processing smart contract resulting in a different value for the attribute. Details regarding the Attributes Registry module 112 and associated mechanisms to set and get associated value are disclosed in US Published Patent Application No. 2019/0164151, incorporated herein by reference in its entirety.

In one embodiment, a request (GetValuation) for a valuation type (e.g., the valuation type “PAR”) is configured via a smart contract executed by the AssetRegistry to point to the corresponding Value attribute (e.g., “PAR” Value attribute) in the Attributes Registry module 112 (FIG. 2). This attribute contains the current principal, that is outstanding balance for the loan which is returned in response to the request. Some valuation results may require a complex, real time analysis of data in order to generate a valuation. To illustrate a separate mechanism for obtaining a valuation, the net asset value (NAV) calculation of the loan is determined based on discounted cash flows and payment behavior of the loan recipient. Specifically, a valuation request for the valuation type “NAV” is operable to utilize smart contract code assigned to the AttributeClass “Loan” via Contract Registry module 108 (FIG. 2), to calculate the net present value (NPV) of the loan based on current interest rates, the interest rate of the loan, and the payment history of the borrower based on cash flows that is operable to be observed in the Asset Wallet. One of ordinary skill in the art will appreciate that net asset value is calculated by dividing the total value of all the cash and/or securities in a fund's portfolio (e.g., bonds), minus any liabilities (e.g., loans), by the number of outstanding shares.

As another example, the “MARKET” value may leverage an oracle, that is a commonly used method to obtain data from sources external to a distributed ledger. As disclosed separately, the Attributes Registry module 112 includes instructions to obtain the latest value, in this case the current exchange price for the asset. Although several examples are provided for clarity, embodiments of the present invention are not limited thereto. However, the means to assign a method to obtain this data that is operable to be configured for each asset provides a novel mechanism to provide “self-reporting assets”. Self-reporting assets are assets that contain within their data structure the means to calculate and publish their valuation. The present invention eliminates the dependency of an auditing or reporting system on the source of valuation data. This eliminates complex system integration required to generate valuations for complex assets, like funds, that contain many different sources of valuation data. Without the disclosed technique, investors often do not have the means to obtain this data. The resulting lack of transparency has devastating effects, as was demonstrated in the 2008 Global Financial Crisis.

The data structures of the requests are shown at 502. Significantly, in the case of composite assets, token 1 owns child tokens and/or serves as a “wrapper” for another token in the manner described above. Token 2 is a child token and/or wrapped token according to one embodiment herein. Token 1 queries all valuation requests for child tokens and/or wrapped tokens, such as token 2 in FIG. 6, in a manner similar to that of valuation requests submitted for Token 1. A get Valuation request (including the valuation model to be applied) for token 2 is sent to token 1. The valuation request is sent to token 2 from token 1 and a valuation of token 2 will be returned by token 2 to token 1. The valuation return is then returned to the requestor by token 1. Thus, the queries are executed prior to responding to the requestor. As shown at 504, when tokens are issued, token issuer functions are operable to enable a valuation to be set.

While embodiments of the present invention disclosed herein expose a common interface for valuation, different techniques enable the calculation of the valuation for the range of asset types that will be supported. Unique smart contract logic to calculate valuation for an asset type is referenced via a known proxy technique, such as via an upgradable storage proxy contract and/or unstructured upgradable storage proxy contract, details of which are available at https://hackernoon.com/how-to-make-smart-contracts-upgradable-2612e771d5a2, last accessed Mar. 6, 2023 and incorporated herein by reference in its entirety. For example, many assets support a par value, that is, a face value. Most managed assets have a Net Asset Value (NAV) calculated based on the market price, liquidity, discounted cash flows, or other assessed value of the contents of the asset. If an asset trades regularly, it will have a market price and value. The par value, NAV, and market value may be different for the same asset. For example, the par value of a loan is based on the outstanding principal, while the NAV is based on the discounted cash flows and probability of default, and the market value of the loan (if the loan is readily traded or has recently been purchased) is based on the price offered and/or paid to acquire the loan. Differences in these values provide insight into changing market perception of asset performance, rating entities, or trust in the asset manager's value assessments. In one embodiment, the present invention calculates these different values. In one embodiment, these differences in value are received via input by a user device. In one embodiment, the present invention automatically updates the differences in valuation using the valuation function.

Asset valuations are operable to be assessed once, periodically, or in continuous real-time or near-real-time. The data format provides information to the viewer (e.g., an owner, an investor) regarding how stale a value assessment is considered to be. Stale value assessments reflect valuations performed on outdated data relating to the asset that has been updated since the valuation, thus rendering the stale value assessment to be invalid. For value assessments that are not yet stale, the data format provides information regarding the interval during which the value assessment is expected to remain valid. Additionally, the specification is operable to provide a link to a standardized feed of valuation history. This provides the reviewer a tool to look at the historical performance of the asset. In one embodiment, a link is provided instead of direct access to the data since the storage, search, and indexing tools needed for historical analysis may be different than the tool (i.e., the distributed ledger) where the asset token is stored.

The embodiments of the invention disclosed herein improve communication of data relating to tokenized assets and thus increase the amount and accuracy of information available to the manager, owner, and investor. The architecture at policy engine 118 of FIG. 2 is operable to control the flow of the data. The policy engine is further operable to create a decision gap by design, as limitations of data flow relating to certain information may be desirable or in the interest of the investor. For example, the asset manager may want to withhold certain information from general availability to prevent “front running.” Front running is used to describe the illegal practice of making trades based on non-public information just before a transaction is made public in order to gain an economic advantage. By withholding certain information from availability, the asset manager advantageously limits the information available to a viewer and thereby decreases the opportunity for a trader or broker to act on the information before it is made to the general public. Withholding certain information further protects investment performance and technique. In one embodiment, the investor chooses to make a tradeoff between performance and transparency. The asset manager is then driven to disclose information based on market demand (i.e., increased performance) balanced against the need for confidentiality (i.e., decreased transparency of information available to a viewer).

As noted herein with respect to FIG. 2, once assets have been tokenized using an IAssetToken interface of the IAsset module 102 the next step in developing a fund according to one embodiment of the present invention is the issuance of a fund token. Fund tokens are issued using the IAssetFund interface structure of the IAsset module 102. This structure extends the IAssetToken structure and functions with the IAssetManagement interfaces, allowing the token to support asset management transactions and further enabling the execution of a fund management strategy. Fund tokens are then issued via the IAssetRegistry interface of Asset Class registry module and assigned a type attribute equal to “Fund” by assigning the value for this class from the Asset class Registry module 106. Of course, a fund is an asset that may contain other assets. The same functions available for an individual asset apply to a fund, such as valuation, data management, and ownership transfer functions. However, funds extend the basic logic of an IAsset token by providing the functions needed to manage the assets contained within the fund.

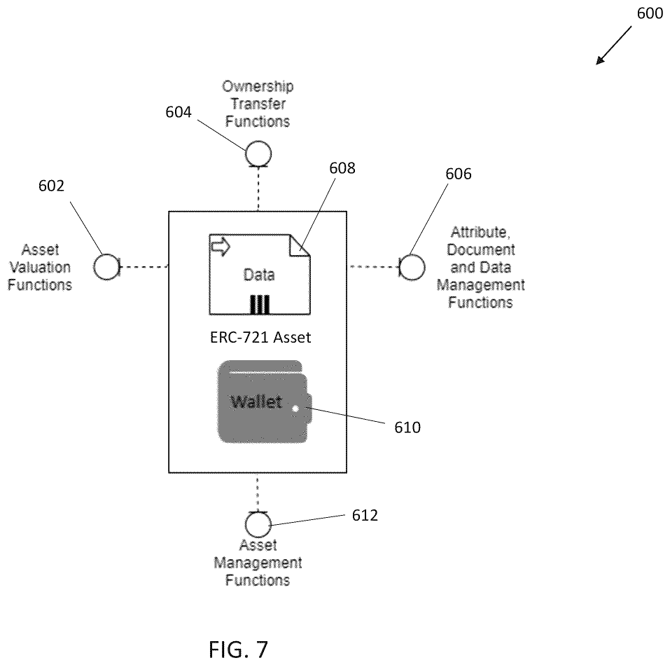

As shown in FIG. 7, a fund asset token 600 according to one embodiment of the present invention is similar to the asset token of FIG. 3 and the associated structure depicted therein, including asset valuation functions 602, ownership transfer functions 604, data management functions 606, recorded data 608, and a cryptographic wallet 610 associated with the token. However, the fund asset management token includes asset management functions 612 that are not present in the asset token of FIG. 3. Asset management functions are implemented via the IAssetManagement interface of Asset Registry module 102, are assigned processing smart contract, and utilize the tokens wallet. All transactions are therefore operable to be recorded on a distributed ledger and are immutable. This provides transparency to simplify recordkeeping, auditing, and reporting. Asset management interfaces provide a consistent transaction infrastructure streamlining the development of logic specific to each asset class or fund management strategy. This facilitates the deployment of management strategies for new asset types executed via internal logic that is operable to be replaced, extended, or upgraded without changing the core token structure and interface footprint. Further, the present invention supports a wide range of asset types via common asset management functions.

More specifically, the IFundManagement.GetAssets interface of fund token 600 extends the basic asset interfaces permitting authorized entities to enumerate all assets in the fund, each of which support the IAsset interface. Enumerating assets in the fund enables the viewer to drill into available information for contained assets. For example, the following fund management functions and related data structures are supported, and an example of each function is included in the Appendix.
addAssetRequest(uint tokenid, uint purchaseTokenid, float price, uint expires, bytes data) external returns (uint orderId);
canceIAddAssetRequest(uint orderId) external returns (bool);
removeAssetRequest(uint tokenid, uint purchaseTokenid, float price, uint expires, address buyer, bytes date) external returns (uint orderid);
cancelRemoveAsstRequest(uint orderid) external returns (bool);
getAssets( ) external return (uint[ ]); //returns an array of addresses of attached non-fungible tokens
event AssetAdded(uint tokenid);
event AssetRemoved(uint tokenid)

Once a fund token has been issued, the next step in a fund creation process is to transfer assets to the fund. Note that a fund is operable to include zero to many assets. In one embodiment, a fund is operable to include zero to 500 assets. In one embodiment, a fund is operable to include zero to 1,000 assets. In one embodiment, a fund is operable to include zero to 5,000 assets. In one embodiment, a fund is operable to include zero to 10,000 assets. In one embodiment, a fund is operable to include zero to 100,000 assets. In one embodiment, a fund is operable to include zero to 1,000,000 assets. In one embodiment, a fund is operable to include zero to 5,000,000 assets. In one embodiment, assets are purchased and added to the fund using the AddAssetRequest function for asset management. In one embodiment, assets are liquidated from the fund using the RemoveAssetFunction for asset management. In one embodiment, the actions regarding asset management are recorded on the distributed ledger. These functions are exposed as interfaces by the Asset Registry module. Fund tokens are further operable to utilize the IAsset token wallet, the ownership transfer functions, asset valuation functions, and data management functions to execute asset transactions. In one embodiment, assets within a fund contain the functions and structure disclosed in FIG. 2. In one embodiment, assets within a fund contain the functions and structure disclosed in FIG. 7.

In one embodiment, a non-fungible fund token 600 is operable to be coupled with (i.e., “wrapped with”) a fungible token using the IAssetManagementFungible interfaces. This is advantageous for the facilitation of trading and other transactions, as funds are operable to be made fungible and therefore transactable. In one embodiment, any asset token is operable to be wrapped with a fungible token implementing the IAssetManagementFungible interface to facilitate fractional ownership of the asset and reuse logic for corporate functions built for non-fungible tokens, such as dividend distributions to shareholders, shareholder voting, corporate communications and more. In one embodiment, tokens implementing the IAssetManagementFungible interface include new smart contract interfaces such as AddAssetRequest and RemoveAssetRequest that extend the ERC20 standard. These interfaces enable the fungible token issuer to add or remove an individual asset from the fungible token shell by transferring the individual asset token using the defined functions in the IAssetManagementFungible interface. In one embodiment, the individual asset token is a non-fungible asset token.

The present invention further includes an interface to permit authorized parties to inspect the asset(s) that underlies the shares represented by the fungible token. This interface, IAssetManagementFungible.GetAsset, advantageously allows for the inspection and verification of assets within a fund. In one embodiment, the IAssetManagementFungible.GetAsset is configured to interface with both individual assets and assets within a fund. The valuation functions exposed by the non-fungible token within the fungible wrapper permit the shareholder (owner of fungible tokens) to easily calculate their percentage ownership of the underlying assets. For example, if the NAV for an underlying asset is $1,000,000 and a wallet holds 100 of 1000 total shares (10%) in circulation of the that asset, then the total NAV of the fungible tokens in that wallet representing 100 shares is $100,000.

The separation of the fungible token from the logic captured in the non-fungible token specific to the asset and management of the asset advantageously facilitates maximum reuse of asset specific code and thus simplifies the development and verification thereof. Additionally, this approach preserves asset structure to facilitate merger or acquisition approaches where asset acquisition is desired instead of share acquisition for tax, governance, or liability reasons. Asset acquisition is a technique in finance wherein a company acquires individual assets rather than purchasing shares of a company. The tax advantages of asset acquisition, such as depreciation and amortization, make asset acquisition favorable in comparison to share acquisition. However, prior art systems lack the flexibility and complexity necessary to facilitate asset acquisition on a large scale (e.g., a composite token with multiple assets associated within a single token). The composite token approach facilitates the transfer of assets to and from exchange traded funds enabling both asset liquidity and convenient management. Assets are easily liquidated when separated from a parent fund using the system of the present invention. When joined with a parent fund (e.g., purchased by a fund for securitization), each asset is easily manageable. Thus, use of the term “fund token” throughout the present disclosure refers to a composite token wherein the contained assets are aggregated into a single fund, represented by the fund token.

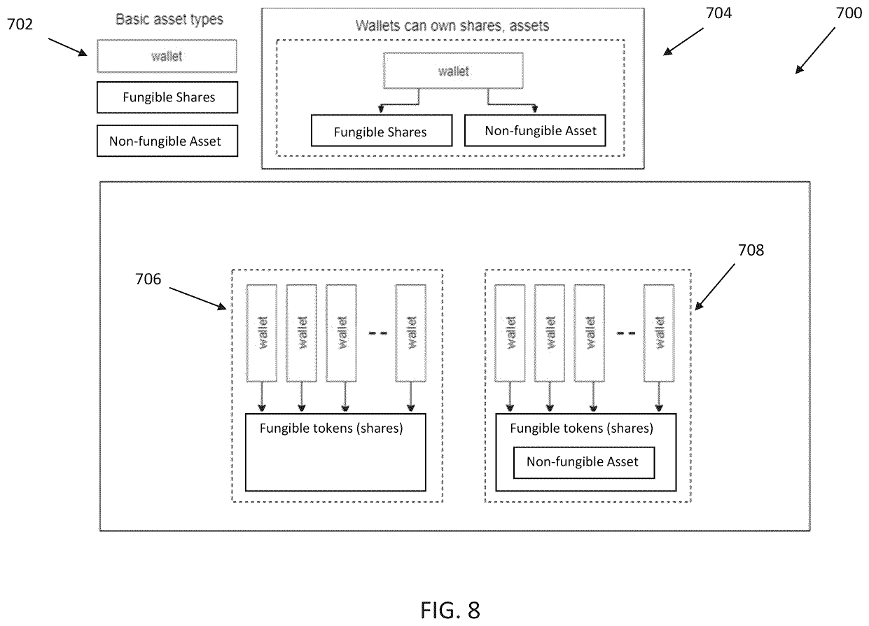

FIG. 8 is a schematic illustration of the data model 700 for wrapping a non-fungible asset token with a fungible token according to one embodiment of the present invention. As previously stated, this enables sharing of an asset. In one embodiment, the fund represented by the wrapped fund token is operable to be fractionally owned. As shown at 702, the basic token types include “wallet”, “fungible share” and “non-fungible asset”. As shown at 704, wallets associated with tokens are operable to own other tokens representing fungible shares and/or non-fungible assets through the mechanisms of the present invention. This simplifies the structure and smart contract code of the non-fungible asset token since it is operable to utilize the dividend distribution and corporate governance function of the non-fungible token wrapper. Shares in a fund are represented by a fungible token and are operable to be owned by one or more wallets or by assets as shown at 706. A smart contract linked to the fungible token exposes ownership and management functions for fungible assets in a fund, as shown at 708. The functions, which are also shown in the Appendix, include:
addAssetRequest(uint tokenId, uint purchaseTokenId, float price, uint expires, bytes data) external returns (uint orderid);
cancelAddAssetRequest(orderId) external returns (bool);
removeAssetRequest(uint tokenId, uint purchaseTokenId, float price, uint expires, address buyer, bytes data) external returns (uint orderId);
cancelRemoveAssetRequest(orderId) external returns (bool);
getAsset( ) external return (uint); //Returns address of attached non-fungible token
event AssetAdded(unit tokenId);
event AssetRemoved(unrt toKenId);

For example, the asset may be a self-processing loan that pays the wallet that owns the asset as loan repayments are received. If this wallet is owned by the fungible token smart contract, these proceeds are distributed proportionally to the owners of the fungible token. The parent-child token structure also facilitates reuse of established transaction logic and exchange functions in fungible tokens while permitting specialization in asset specific functions, in this case, loan processing. In one embodiment, a fund is operable to have as few as zero (null) assets, as the fund is defined by the fungible token and the linked management smart contract. In one embodiment, a fund token is operable to be created according to one embodiment of the present invention without requiring the association of an individual asset with the token.

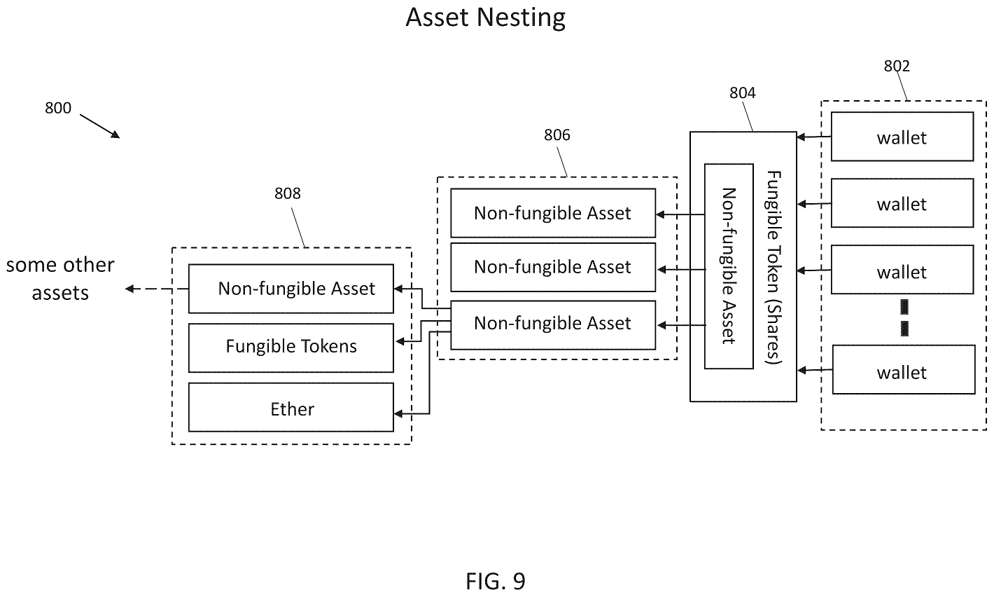

FIG. 9 is a schematic representation of the data model 800 for nesting of tokens (i.e., creation of composite tokens) according to one embodiment of the present invention. A composite token is operable to contain assets, asset tokens for other funds, fungible shares of other assets, and/or shares of fund assets. It is therefore advantageous of the present invention to enable the creation of composite tokens by allowing token nesting. Token nesting facilitates a token of tokens structure wherein a token is operable to contain additional tokens, thus creating a composite token. The composite token is operable to include additional composite tokens, thereby advantageously providing techniques for large-scale portfolio diversification, as nested tokens are operable to contain multiple assets from a variety of asset types. In one embodiment, the tokens nested within a composite token are assigned different classes. One of ordinary skill in the art will appreciate that assets assigned to different classes are considered to be heterogeneous.

Token wallets 802 are operable to own fungible tokens representing shares in a fund 804 which in turn owns non-fungible assets 806. Further, non-fungible assets 806 are operable to own additional assets 808, including but not limited to non-fungible tokens, fungible tokens, and other assets (e.g., the cryptocurrency Ether) are operable to be owned by the non-fungible tokens. The wallet structure and architecture of the present invention permit recursive ownership of assets and further enable transparency regarding ownership.

In the same way that the IAssetFund extends the IAsset structure to implement Fund management functions, the IAsset structure is operable to be extended for other asset types to permit token polymorphism. For example, in one embodiment of the present invention, the system is operable to issue IAssetLoan tokens, that is, tokens with a class type Loan from Asset Class Registry module 106 of FIG. 1. This class is operable to implement self-processing loans, that is, loans that process payments internally via the IAsset wallet and assigned ProcessWaterfall smart contract logic. Custom smart contracts for payment processing are operable to be assigned to loans by their owner using the AssignWaterfallProcess interface. In one embodiment, the custom smart contract is a smart contract that is not associated with the asset class assigned to the asset. This practice of enabling functions to be superseded by a derived class through inheritance is known as overloading. Overloading using the interface structure permits the execution of different loan processing strategies within the same fund.

By inheriting the IAsset structure, an IAssetLoan token is operable to receive payment to an associated wallet in any accepted currency, process the payment, update any outstanding principal and process fees, and pass the proceeds to the owner of the wallet. All transactions and payments are operable to be inspected on the ledger providing transparency and data needed for asset valuation. Using the IAssetFund Asset Management Functions, the IAssetLoan token is operable to be attached to a fund token. The loan token is operable to be one of many IAssetLoan tokens. The use of such tokens create a securitized fund. Loan payments are processed automatically by each loan with proceeds passed to the parent fund where they are processed further as management fees, dividend distributions, and other fund functions as managed by the IAssetFund token. This structure creates a fully transparent, self-processing securitized loan pool that scales indefinitely.

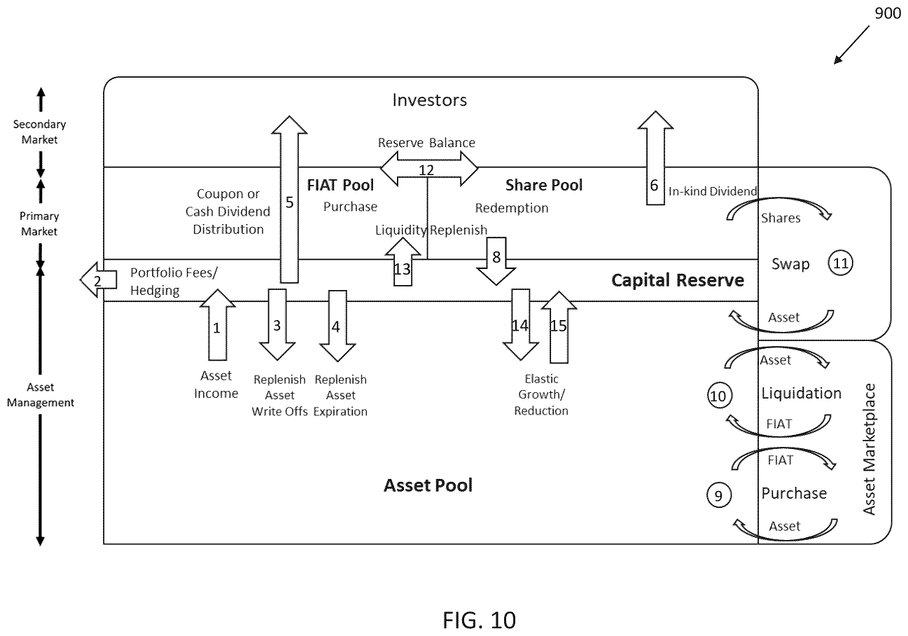

Self-processing, self-reporting loan assets in a self-processing, self-reporting fund provide increased transparency in comparison to the prior art, specifically in comparison to the massive, securitized loan (e.g., RMBS) funds that were at the root of the Global Financial Crisis. The present invention enables the creation of funds containing a variety of asset types, providing investors access to a diverse set of new investment opportunities. Further, the data model and architecture of the present invention simplifies the automation of more advanced fund management strategies. FIG. 10 is a schematic illustration of a fund management environment 900 with common transactions for asset management in the primary and secondary market. The present invention supports each of the operations through the use of the IAsset interface and IAssetFund interface. Each transaction of FIG. 10 is described below. Income from fund assets initiate a waterfall process selectively applied to the token of the present invention.

One of ordinary skill in the art will appreciate that certain waterfall steps will occur to one of ordinary skill in the art upon reading the present invention. The process depicted in FIG. 10 is not considered exhaustive, and additional collection, distribution, and balances relating to processing of income generated by fund assets, while not specifically disclosed herein, are considered to be within the scope of the present invention.

Further, the process depicted in FIG. 10 illustrates the elastic securitization of a fund token. Elastic securitization is a process that allows for growth and reduction of a fund containing illiquid assets. The process addresses a market need to provide fund structures to facilitate exchange trading of illiquid assets. Such fund structures provide a liquidity buffer between liquid assets trading on an exchange and illiquid assets in the underlying fund. This advantageously addresses the concerns implicated by 17 CFR 270.22e-4, also known as SEC Rule 22e-4, which requires funds, including ETFs, to establish liquidity risk management programs and prevents funds comprising more than 15 percent of illiquid investments from purchasing additional illiquid investments.

Process Asset Income to the Capital Reserve (1): Income earning assets in the Asset Pool process income using automated internal and/or automated external models. In one embodiment, a fund token owner, token issuer, and/or fund manager is operable to manually process and distribute income from fund assets. Income earning assets include but are not limited to leases, bonds, debt instruments, and dividend paying shares. These earnings are processed via the asset wallet for distribution providing full traceability of asset performance. When the fund token owner executes a ProcessWaterfall request via the IAsset interface, a ProcessWaterfall request is called for each of the IAssets owned by the fund. As a result of this request, the fund's assets transfer earnings to the Capital Reserve (IAsset wallet) of the fund. The fund executes internal waterfall logic to process these earnings. In one embodiment, the waterfall logic is a plug-in smart contract. In one embodiment, the waterfall logic is a set of set of smart contracts. In one embodiment, the waterfall logic is a set of plug-in smart contracts. This advantageously supports innovative or repeatable fund management strategies within the fund. On completion of processing, funds are transferred to the token owner as defined by the processing logic of the token. In one embodiment, the token owner is operable to execute additional distribution logic.

Process Portfolio Hedging/Management Fees (2): In one embodiment, fund waterfalls include payment of asset management fees. In one embodiment, the present invention includes internal services for fund operations, such as hedging and insurance. These fees are paid out of the Capital Reserve (asset wallet) using wallet transfer logic and are operable to be executed via the waterfall logic smart contract. To maintain a consistent par value of the fund, these payments must be replenished from asset income or other sources.

Process Replenish Write Offs/Turnover (3): Assets are operable to be written off (residual value deemed to be zero) in a given period. Write offs result from defaulted loans or underperforming assets. To maintain constant par value, write offs must be replenished using assets from the Capital Reserve as part of the processing waterfall. Sufficient balance is retained in the Capital Reserve to support “at risk” income streams (e.g., overdue loans or underperforming assets that may default in upcoming periods).

Process Replenish Asset Expiration (4): For certain types of funds, such as those consisting of expiring, illiquid assets, asset residual values (i.e., earning potential) are reduced as income is processed from the asset. For example, a payment on a mortgage that reduces the principal of the loan results in a reduction in the earning potential of the asset (i.e., residual value). To maintain a consistent earning potential of the fund, the residual should be replaced through the purchase of assets with similar or better earning potential. Realized earning potential results in a reduction of the residual value of the asset pool (i.e., expiration) while increasing cash in the funds Capital Reserve. Asset purchases using Capital Reserve assets use the IAsset CreatePurchaseOrder function. The addition of funds from realized income generated by the underlying asset (e.g., distribution payments) typically increases the overall NAV of the portfolio proportional to the income stream risk asset. As funds are added to the Capital Reserve balance from the asset generated fund, the value of the asset decreases causing a decrease in the NAV of the asset pool. However, the increase in Capital Reserve balance exceeds the reduction in NAV of the asset pool, thus creating an overall increase in NAV. Portfolios consisting of rapidly expiring assets will see significant expiration in a given period as the assets within the portfolio expire. The higher the expiration percentage of assets within the portfolio, the greater the elasticity ratio of the fund relative to the elasticity of underlying assets.

Process Coupon or Dividend Distributions (5): In one embodiment, funds offer coupon income or cash dividends to owner and/or shareholders. The term “cash” as used herein refers to any asset (e.g., fiat, crypto, or other asset types) but is typically liquid, readily traded for shares of the fund, and in the same asset type as the asset income. In one embodiment, Coupon Distributions are paid before other fund payments while Dividend Distributions are made from the proceeds that remain after other waterfall responsibilities are met. In one embodiment, Coupon Distributions are less than the overall expected income from fund assets. This advantageously stabilizes the fund in the case of asset income volatility or uncertainty. Distributions are made via the ProcessWaterfall method. A Compliance Aware Token (CAT) is a fungible token that contains shareholder distribution functions. By attaching the asset token to the fungible token, distributions to the shareholders of the fund are processed automatically and at scale. It is advantageous of the present invention to include Coupon Distributions or Dividend Payments, as these distributions and payments increase the flexibility of the present invention by providing additional means for payment and fund management. Specifically, asset income such as receiving payment increases the par value of the fund.

Process In-kind Share Dividend (6): In one embodiment, rather than cash dividends, funds pay distributions using shares of the fund. This strategy is used for some funds for tax purposes or to enhance liquidity. Funds from the Capital Reserve are used to purchase the shares to be distributed. These shares are purchased using several strategies, including but not limited to purchasing from a liquid secondary market, purchasing from a liquidity reserve pool in the primary market, or by issuing share tokens consistent with the funds NAV. The flexibility of the share purchase, redemption, and distribution model enables the IAssetFund structure to support any existing fund management strategy including but not limited to ETFs, mutual funds, or closed-end funds. This also supports fund revenue optimization strategies for tax or liquidity benefits.

Process Primary Market Purchase (7): In one embodiment, the IAssetFund token is attached to a fungible token to facilitate fractional ownership. Investors may purchase or sell fund shares in the primary market using the SharePurchaseRequest and SharePurchaseSwapRequest methods supported by the fungible token interface. For open-ended funds (i.e., funds where the share count may change based on market demand for the underlying asset) shares are issued (i.e., purchased) or burned (i.e., redeemed) to support the request. A share is issued upon the purchase of a share by a user, while a share is burned upon the redemption of the share by a user. Based on the operating model of the fund, shares are delivered to the purchasing party in exchange for assets or cash-in-lieu (CIL) of assets. SharePurchaseRequest is a CIL transaction. The SharePurchaseRequest is made, the NAV is assigned, and the purchaser must fulfill the by supplying the “cash” assets required to fulfill the order. The IAssetFund token receives the cash and must purchase or assign the underlying from an asset marketplace or using the IAsset CreatePurchaseRequest function. SharePurchaseSwapRequest is used for transactions where the assets used for share purchase are consistent with the investment thesis or index (ratio of shares to underlying assets in the fund) of the fund. For this type of transaction, shares are sold at the fund's strike price. As used herein, “strike prices” refers to the NAV of the fund divided by the total number of shares.

Process Primary Market Redemption (8): This transaction is the opposite of the Primary Market Purchase transaction. Shares of the fungible token are sold to the fund in exchange for cash (ShareRedeemRequest), or assets from the underlying fund (ShareRedeem SwapRequest). Depending on the cash in the Capital Reserve, it may be necessary to liquidate assets from the IAssetFund token using CreateSellRequest.

In one embodiment, a liquidity reservoir is established as a part of the fungible token to enable elastic securitization. In one embodiment, the liquidity reservoir is a smart contract that prices Primary Market transactions based on the net inflow or outflow of capital to the fund. In one embodiment, the liquidity reservoir is a smart contract that prices Secondary Market limit orders based on the net inflow or outflow of capital to the fund. The liquidity reservoir maintains a pool of shares and cash that fulfills orders generated by the system of the present invention. Share price is adjusted based on the deviation of the reserve pool balance from the desired balance as set by the fund manager. For example, a significant inflow of capital via an imbalance of SharePurchaseRequests will increase the cash available in the fiat pool, also referred to as the “cash pool” in the reservoir while decreasing the shares available in the share pool. One or more pricing algorithms based on fund manager strategy increases share price in the reserve pool increasing the likelihood of a redemption while decreasing the demand for new purchases, as shares are more likely to be sold at an increased price and less likely to be purchased at an increased price. The algorithms react to adjust the price of liquidity in the face of changes in investor demand to return the reservoir to balance. In one embodiment, the algorithms are smart contract plug-ins.

Process Asset Purchase (9): In one embodiment, portfolio managers purchase assets using cash from the Capital Reserve. These purchases use the CreatePurchaseRequest function of the IAsset module. In one exemplary embodiment, assets that expire are replaced with cash from the Capital Reserve, which is replenished by asset income. The portfolio manager is further responsible for creating NAV assessments and implementing hedging strategies while managing asset purchases. These assessments and strategies reflect the overall alpha of a portfolio and therefore impact the likelihood of investment in the fund. The present invention advantageously provides smart contract plug-ins for specific strategies, decreasing the time required to individually implement such strategies.

Process Asset Liquidation (10): If the Reserve Balance (12) falls below the liquidation threshold, actions are triggered requiring portfolio managers to sell assets to restore portfolio liquidity requirements. In one embodiment, these triggers are enacted via smart contracts and are executed through the CreateSellRequest function of the IAsset module.

Process Swap (11): In other portfolios, assets enter the portfolio via swaps, i.e. exchanges of income earning shares for rights to asset earning potential. Some portfolios may use both techniques to acquire assets. The use of a swap vice cash purchases are preferred as this introduces additional liquidity into the portfolio.

Reserve Balance (12): In one embodiment, the reserve pool of the present invention comprises a fiat pool and a share pool. The Reserve Balance is the balance between the portion of the reserve pool comprising the fiat pool and the portion of the reserve pool comprising the share pool. The fund manager is responsible for setting and maintaining the Reserve Balance.

Process Replenish Liquidity Reservoir (13): In an elastic securitization model applied to a fund of income producing assets, cash distributions are used to restore liquidity in the liquidity reservoir if the cash levels of the liquidity reservoir are low. In one embodiment, the determination of a low cash level is based on the number and/or frequency of shareholders selling shares in the fund. If there is a sustained exodus of shareholders leaving the fund, the cash level is considered to be low. The amount of reservoir liquidity to be restored in this step is determined algorithmically. In one embodiment, determination of the amount of reservoir liquidity to be restored is determined by one or more algorithms, including considerations for Liquidity Reservoir Balance, Capital Reserve, and market conditions. If significant liquidity restoration is required, resources may be unavailable to replenish expiring assets resulting in a reduction of the par value of the portfolio. If income levels fall below the liquidation threshold, this triggers asset liquidation.

Process Elastic Portfolio Growth (14): A sustained price above the NAV resulting from a sustained imbalance of purchase orders creates a cash imbalance in the Reservoir. If this price exceeds the NAV by a threshold, the assets are operable to be transferred to the Capital Reserve to purchase more assets into the fund driving the growth of the overall NAV of the fund. Using this model, the NAV of the fund grows elastically without the use of Authorized Participants or the issuance of new shares.

Process Elastic Portfolio Reduction (15): Investor liquidity needs may result in a net outflow of value from the cash pool. A sustained imbalance resulting in pricing below NAV signals a need to liquidate assets from the fund to provide the cash needed to restore the cash pool. In one embodiment, the system of the present invention is operable to reduce the influence of a fund manager based on sustained portfolio underperformance of assets under his or her control. This advantageously provides elastic fluctuation in par value based on investor demand and asset performance for a closed fund, whereas such characteristics are typically only found in open funds of prior art systems.

The flexibility of the linked IAssetFund and IAsset structure provides a mechanism to execute common and advanced fund management strategies. The structure makes it possible to automate common asset management functions and inject fund management strategies while providing a transparency and simplified auditing and reporting. Linking fungible tokens to the non-fungible IAssetFund token provides new utility for fund shares. Shares of a fund according to the system of the present invention are operable to be held for income (i.e., by dividend payment) or growth, transferred as payment, held in escrow as collateral, monetized through exchange in authorized secondary markets for USD, BTC, EUR, or other securities, and/or used to participate in fund governance through proxy voting.

The present invention enables fund assets to be purchased or redeemed from the asset pool using fund shares via a swap mechanism (i.e., a derivative contract where parties are able to exchange fund assets and/or cash from different financial assets). This creates a “backing” model enabling assets to be added and/or removed from the fund using token issuance and destruction. One embodiment of the present invention includes a liquidity pool to manage the net inflow and outflow of capital into the fund. A liquidity algorithm is operable to be applied to set share price to help manage redemptions and facilitate the formation of a secondary market for the fund's shares. This model is repeatable and is used to meet nearly any fund structure: Lending, Debt Instruments, Receivables, Structured Settlements, Factoring, Trade Finance, Insurance, Leases, etc.

As one example of a fund structure that is automated by system of the present invention, a closed-end Lending Pool fund is created leveraging a fund smart contract. The pool is funded from existing assets, warehoused loans, rehypothecation, and/or capital formation. At first, the pool contains only the capital (fiat or crypto) needed for lending. Using the fund smart contract format, the Pool exposes a NAV and par value (sum of the NAV and par value of all assets in the pool) and publishes supporting documents and a list of assets in real time. All fund transactions are recorded on an immutable ledger. The pool has a Portfolio Manager, Asset Manager(s), and optionally other services (hedging, asset insurance, etc.) Loans are originated by authorized agents and funds disbursed through an automated process. On origination, loans are added as assets to the fund. According to some embodiments of the present invention disclosed herein, all assets (available lending capital, receivables, and other assets) are operable to be viewed by authorized parties in real time.

Loans are originated from the pool as smart contracts extending the smart contract of the asset. This facilitates securitization, fund operations, and compliant transfers. As asset objects, they publish supporting documentation, transaction history, and real time asset NAV and par value to authorized viewers. Loan Tokens leverage the IAsset structure to publish loan characteristics to enable independent analysis and valuation. In one embodiment, loan tokens are wrapped in ERC-20, ERC-721, or other tokens to govern and facilitate transfers.

Valuation and payment processing logic are incorporated in the loan token. Payments are made via simple transfers to an address specific to the loan. In one embodiment, a user is operable to scan a QR code using a device in order to access an address specific to the loan. The user is then able to create a purchase request and/or sell order in order to acquire or sell the loan token. Payments are processed and proceeds are transferred to the asset owner. The par value and NAV for each loan are updated in real time with each payment. Transaction history for each loan is recorded on an immutable ledger and available for analysis by authorized users.

Pool Payment processing is automated and transparent. Proceeds from repayment of individual loan assets in the fund are transferred to the Risk Pool for further processing Risk Pool processing logic leverages a customizable smart contract to automate redemptions, loan write-offs, Pool capital replenishment, management fees, and dividend & coupon payments via a transparent and verifiable waterfall. Dividend and coupon payments and other distributions are transferred automatically to fund owners using fund logic embodied in a smart contract.

For enhanced liquidity and risk management, assets may be sold from (or purchased into) the portfolio. Supported asset transactions include purchase/sale via loan markets, redemptions and swaps using fund tokens. Other transactions include collections and write-offs. Dividend payments are operable to be made in cryptocurrency, fiat, or in-kind pool tokens. Tokens are issued through many avenues, including but not limited to primary market offering, auction, and tokenization of existing interests. Shareholders (i.e., holders of tokenized shares) receive coupon and dividend distributions automatically and proportional to share ownership. The result is dividend paying tokens. Asset backed security tokens are revolutionary financial instruments. The tokens are operable to be: (1) held to receive a dividend; (2) transferred as payment; (3) held in escrow as collateral; and/or (4) monetized through exchange in authorized secondary markets for fiat currency, cryptocurrency, or other securities.

Using elastic securitization mechanisms, growth in demand for tokens results in an influx of capital. Additional capital results in expansion of lending pool PAR value providing more assets for lending. This model enables indefinite growth, advantageously allowing for the addition of increased quantities of assets and funds in comparison to prior art systems, which are limited in the number of assets operable to be added to the system. Similarly, capital exodus caused by underperformance or other factors results in a controlled drawdown of portfolio NAV. This model is repeatable and is operable to be used to meet nearly any securitization need, including lending, debt instruments, receivables, structured settlements, factoring, trade finance, insurance, leases, and the like.

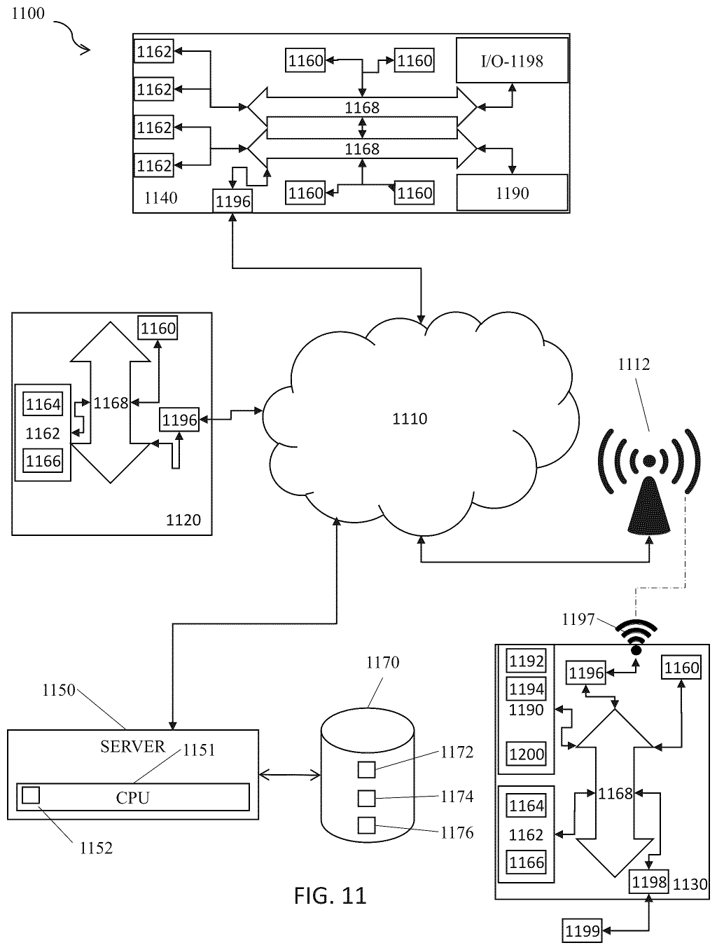

FIG. 11 is a schematic diagram of an embodiment of the invention illustrating a computer system, generally described as 1100, having a network 1110, a plurality of computing devices 1120, 1130, 1140, a server 1150, and a database 1170.

The server 1150 is constructed, configured, and coupled to enable communication over a network 1110 with a plurality of computing devices 1120, 1130, 1140. The server 1150 includes a processing unit 1151 with an operating system 1152. The operating system 1152 enables the server 1150 to communicate through network 1110 with the remote, distributed user devices. Database 1170 is operable to house an operating system 1172, memory 1174, and programs 1176.

In one embodiment of the invention, the system 1100 includes a network 1110 for distributed communication via a wireless communication antenna 1112 and processing by at least one mobile communication computing device 1130. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 1100 is a virtualized computing system capable of executing any or all aspects of software and/or application components presented herein on the computing devices 1120, 1130, 1140. In certain aspects, the computer system 1100 is operable to be implemented using hardware or a combination of software and hardware, either in a dedicated computing device, or integrated into another entity, or distributed across multiple entities or computing devices.

By way of example, and not limitation, the computing devices 1120, 1130, 1140 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit the scope of the invention described and/or claimed in the present application.

In one embodiment, the computing device 1120 includes components such as a processor 1160, a system memory 1162 having a random access memory (RAM) 1164 and a read-only memory (ROM) 1166, and a system bus 1168 that couples the memory 1162 to the processor 1160. In another embodiment, the computing device 1130 is operable to additionally include components such as a storage device 1190 for storing the operating system 1192 and one or more application programs 1194, a network interface unit 1196, and/or an input/output controller 1198. Each of the components is operable to be coupled to each other through at least one bus 1168. The input/output controller 1198 is operable to receive and process input from, or provide output to, a number of other devices 1199, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 1160 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 1140 in FIG. 11, multiple processors 1160 and/or multiple buses 1168 are operable to be used, as appropriate, along with multiple memories 1162 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 1100 is operable to operate in a networked environment using logical connections to local and/or remote computing devices 1120, 1130, 1140 through a network 1110. A computing device 1130 is operable to connect to a network 1110 through a network interface unit 1196 connected to a bus 1168. Computing devices are operable to communicate communication media through wired networks, direct-wired connections or wirelessly, such as acoustic, RF, or infrared, through an antenna 1197 in communication with the network antenna 1112 and the network interface unit 1196, which are operable to include digital signal processing circuitry when necessary. The network interface unit 1196 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 1162, the processor 1160, and/or the storage media 1190 and is operable be a single medium or multiple media (e.g., a centralized or distributed computer system) that store the one or more sets of instructions 1200. Non-transitory computer readable media includes all computer readable media, with the sole exception being a transitory, propagating signal per se. The instructions 1200 are further operable to be transmitted or received over the network 1110 via the network interface unit 1196 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 1190 and memory 1162 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 1100.

In one embodiment, the computer system 1100 is within a cloud-based network. In one embodiment, the server 1150 is a designated physical server for distributed computing devices 1120, 1130, and 1140. In one embodiment, the server 1150 is a cloud-based server platform. In one embodiment, the cloud-based server platform hosts serverless functions for distributed computing devices 1120, 1130, and 1140.

In another embodiment, the computer system 1100 is within an edge computing network. The server 1150 is an edge server, and the database 1170 is an edge database. The edge server 1150 and the edge database 1170 are part of an edge computing platform. In one embodiment, the edge server 1150 and the edge database 1170 are designated to distributed computing devices 1120, 1130, and 1140. In one embodiment, the edge server 1150 and the edge database 1170 are not designated for distributed computing devices 1120, 1130, and 1140. The distributed computing devices 1120, 1130, and 1140 connect to an edge server in the edge computing network based on proximity, availability, latency, bandwidth, and/or other factors.

It is also contemplated that the computer system 1100 is operable to not include all of the components shown in FIG. 11, is operable to include other components that are not explicitly shown in FIG. 11, or is operable to utilize an architecture completely different than that shown in FIG. 11. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

### Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

### Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

### Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

COMPUTER PROGRAM LISTING APPENDIX

```
  pragma solidity >=0.6.0 <0.7.0;
  /**
  * @title AssetRegistry base contract
  * Assets are represented by a non-fungible (ERC721) token and can be owned by one or
multiple wallets or by assets.
  * All Assets will contain an embedded wallet making it possible to own other assets
  * Assets may be have a class from the AssetClassRegistry
  abstract contract IAssetRegistry {
    /**
    * @notice NFT issued
    * @param uuid NFT unique identifier
    */
    event AssetIssued(uint uuid);
    /**
    * @notice NFT removed
    * @param uuid NFT unique identifier
    */
    event AssetBurned(uint uuid);
    /**
    * @notice Create a request to puchase the designated NFT to the fungible token in
exchange for value, creates a purchase order
    * @param uuid NFT token identifier (must be unique)
    * @param name NFT token name
    * @param class (optional) AssetClassRegistry class token (class contact &
uniqueId)
    * @param data (optional) additional data for policy enforcement
    * @return tokenId unique identifier for the issued token
    */
    function issueAsset(
      uint uuid,
      bytes32 name,
      address class,
      bytes calldata data
    )
      external
      virtual
      returns (uint tokenId);
    /**
    * @notice Remove the asset token
    * @param uuid token unique identifier
    */
    function burnAsset(uint uuid) external virtual returns (bool);
    /**
    * @notice Get the wallet for the asset
    * @param uuid token unique identifier
    * @return class address for the asset's class in the class registry
    */
    function getClass(uint uuid) external virtual returns (address class);
  }
  pragma solidity >=0.6.0 <0.7.0;
  /**
  * @title AssetClassRegistry base contract
  *
  * Assets may be assigned to an asset class.
  * Asset classes are NFTs and may be owned. Ownership will carry specific rights over
the class, its properties, and instances
  * Asset classes may have required or optional attributes from the AttributeRegistry
  * Asset classes support inheritance (a class may extend its parent)
  * Asset classes may be used in conjunction with the rules engine
  abstract contract IAssetClassRegistry {
    /**
    * @notice Asset Class created
    * @param classId of asset class
    */
    event Created(uint classId);
    /**
    * @notice Asset Class removed
    * @param classId of asset class
    */
    event Removed(uint classId);
    /**
    * @notice Create a request to purchase the designated NFT to the fungible token in
exchange for value, creates a purchase order
    * @param classId class unique identifier
    * @param name class unique name
    * @param description (optional) class description
    * @param parentid (optional) parent if inheriting from class
    * @param data (optional) additional data for policy enforcement
    * @return classId unique identifier for the class
    */
    function createClass(
      uint classId,
      bytes32 name,
      bytes32 description,
      uint parentId,
      bytes calldata data
    )
      external
      virtual
      returns (uint classId);
    /**
    * @notice Remove the asset class
    * @param classId class unique identifier
    */
    function removeClass(uint classId) external virtual returns (bool);
  }
  pragma solidity >=0.6.0 <0.7.0;
  /**
  * @title Asset Ownership Transfer Functions
  *
  * Asset tokens implement ERC721 standard interfaces.
  * This includes all ownership transfer functions designed in the specification.
  * The tokens also implement the Compliance Aware Token framework for token
  * clawback and policy enforcement. The asset token extends this framework with
  * the functions below to enable systematic asset purchase, sale, and linking.
  */
  abstract contract IAssetTransferable {
    /// Asset Token Sale
    /**
    * @notice Create a request to sell the designated NFT in exchange for value
    * @param assetId Target NFT unique identifier
    * @param exchangeToken the token used to be exchanged for the target token
    * @param price the amount (fungible token only) of exchange token that will be
provided for the transaction
    * @param expires when the request will expire if not executed
    * @param buyer designated a specific wallet that can execute the order
    * @param data (optional) additional data for policy enforcement
    * @return orderId unique identifier tracking the request for the token
    */
    function createSellOrder(
      uint assetId,
      address exchangeToken,
      uint price,
      uint expires,
      address buyer,
      bytes calldata data
    )
      external
      virtual
      returns (uint orderId);
    /**
    * @notice Cancel the order associated with the requested asset transfer
    * @param orderId Identifier for the order associated with the the request
    */
    function cancelSellOrder(uint orderId) external virtual returns (bool);
    /**
    * @notice Accept the order associated with the requested asset transfer
    * @param orderId Identifier for the order associated with the the request
    */
    function acceptSellOrder(uint orderId) external virtual returns(bool);
    /// Asset Token Purchase
    /**
    * @notice Create a request to purchase the designated NFT in exchange for value
    * @param assetId Target NFT unique identifier
    * @param exchangeToken the token used to be exchanged for the target token
    * @param price the amount (fungible token only) of exchange token that will be
provided for the transaction
    * @param expires when the request will expire if not executed
    * @param data (optional) additional data for policy enforcement
    * @return orderId unique identifier tracking the request for the token
    */
    function createPurchaseOrder(
      uint assetId,
      address exchangeToken,
      uint price,
      uint expires,
      bytes calldata data
    )
      external
      virtual
      returns (uint orderId);
    /**
    * @notice Cancel the order associated with the requested asset transfer
    * @param orderId Identifier for the order associated with the the request
    */
    function cancelPurchaseOrder(uint orderId) external virtual returns (bool);
    /**
    * @notice Accept the order associated with the requested asset transfer
    * @param orderId Identifier for the order associated with the the request
    */
    function acceptPurchaseOrder(uint orderId) external virtual returns(bool);
    /**
    * @notice Reject the order associated with the requested asset transfer
    * @param orderId Identifier for the order associated with the the request
    */
    function rejectPurchaseOrder(uint orderId) external virtual returns(bool);
    /**
    * @notice Get the wallet for the registry used for purchases
    * @return wallet Address for the registry's wallet
    */
    function getPurchasewallet( ) external virtual returns (address wallet);
    /** @notice handle receipt of fungible tokens as payment for non-fungible asset
    * @dev The smart contract calls this function on the recipient
    * after a ‘transfer’. This function MAY throw to revert and reject the
    * transfer. Return of other than the value MUST result in the
    * transaction being reverted.
    * Note: the contract address is always the message sender.
    * @param operator The address which called ‘transferFrom’ function
    * @param from The address which executed the purchase and transferred the purchase
tokens
    * @param orderId Identifier for the order associated with the the request
    * @param data Additional data with no specified format
    * @return ‘bytes4(keccak256(“onPurchaseReceived(address, address, uint, bytes)”))’
    */
    function onPurchaseReceived(address operator, address from, uint orderId, bytes
data) external returns(bytes4);
  }
  pragma solidity >=0.6.0 <0.7.0;
  /**
  * @title Asset Management Functions
  */
  abstract contract IAssetManagement {
    /**
    * @notice Write info to the log when asset was added
    * @param assetId NFT uuid that added token
    * @param token that was added (allows external NFTs)
    */
    event AssetAdded(uint assetId, address token);
    /**
    * @notice Write info the the log when asset was removed
    * @param assetId NFT uuid that removed token
    * @param token that was removed (allows external NFTs)
    */
    event AssetRemoved(uint assetId, address token);
    /**
    * @notice Create a request to puchase the designated NFT to the parent token in
exchange for value, creates a purchase order
    * @param assetId NFT to receive requested token
    * @param token target NFT (allows external NFTs)
    * @param exchangeToken the token used to be exchanged for the target token
    * @param price the amount (fungible token only) of exchange token that will be
provided for the transaction
    * @param expires when the request will expire if not executed
    * @param data (optional) additional data for policy enforcement
    * @return orderId unique identifier tracking the request for the token
    */
    function addAssetRequest(
      uint assetId,
      address token,
      address exchangeToken,
      uint price,
      uint expires,
      bytes calldata data
    )
      external
      virtual
      returns (uint orderId);
    /**
    * @notice Cancel the order associated with the requested asset transfer
    * @param orderId Identifier for the order associated with the the request
    */
    function cancelAddAssetRequest(uint orderId) external virtual returns (bool);
    /**
    * @notice Create a request to sell the designated NFT from the parent token in
exchange for value, creates a sell order
    * @param assetId NFT that owns target token
    * @param token target token
    * @param exchangeToken the token used to be exchanged for the target token
    * @param price the amount (fungible token only) of exchange token that will be
provided for the transaction
    * @param expires when the request will expire if not executed
    * @param data (optional) additional data for policy enforcement
    * @return orderId unique identifier tracking the request for the token
    */
    function removeAssetRequest(
      uint assetId,
      address token,
      address exchangeToken,
      uint price,
      uint expires,
      address buyer,
      bytes calldata data
    )
      external
      virtual
      returns (uint orderId);
    /**
    * @notice Cancel the order associated with the requested asset transfer
    * @param orderId Identifier for the order associated with the the request
    */
    function cancelRemoveAssetRequest(uint orderId) external virtual returns (bool);
    /**
    * @notice Returns an array of addresses of attached non-fungible tokens
    * @param assetId NFT that owns list of assets to be returned
    */
    function getAssets(uint assetId) external virtual view returns (address[ ]
memory);
  }
```

The invention claimed is:

1. A system for storage and management of tokenized assets comprising:
a decentralized computer platform including at least one module, a distributed ledger, and a server including a database;
wherein the decentralized computer platform is stored on the database of the server;
wherein the server is in network communication with at least one user device;
wherein the decentralized computer platform is operable to be accessed by the at least one user device;
wherein the decentralized computer network is implemented by the distributed ledger;
wherein the decentralized computer platform is operable to issue a unique token identifier associated with an asset to create an asset token;
wherein the asset token is assigned a class, wherein the class includes at least one property and/or at least one function, wherein the assignment of the class enables the asset token to expose, display, and/or execute the at least one property and/or the at least one function specific to the class; and
wherein the decentralized computer platform executes at least one internal waterfall logic to process income generated by the asset token.

2. The system of claim 1, wherein the internal waterfall logic is determined by the asset class assignment of the asset token, wherein the at least one property and/or the at least one function specific to the asset class determines at least one step in the internal waterfall logic.

3. The system of claim 1, wherein the decentralized computer platform is operable to receive an input of at least one alternative internal waterfall logic, wherein the alternative internal waterfall logic comprises a set of smart contracts for processing income generated by the asset token.

4. The system of claim 1, wherein the at least one internal waterfall logic comprises at least two smart contracts, wherein deployment of a first smart contract of the at least two smart contracts initiates deployment of a second smart contract of the at least two smart contracts.

5. The system of claim 1, wherein execution of the at least one internal waterfall logic is initiated in real-time upon addition of income to the asset token.

6. The system of claim 1, wherein the at least one decentralized computer platform includes an indication of at least one party authorized to view the asset token, wherein data relating to the asset token is available to the at least one authorized party in real-time.

7. The system of claim 1, wherein issuance of the asset token initiates the deployment of a smart contract for associating the asset token with a wallet.

8. The system of claim 7, wherein the decentralized computer platform includes an interface for adding at least one additional asset token to the wallet containing the asset token.

9. The system of claim 1, wherein the decentralized computer platform includes at least one plug-in point, wherein at least one logic, at least one smart contract, and/or at least one updated module is operable to be added to the decentralized computer platform via the at least one plug-in point.

10. A system for storage and management of tokenized assets comprising:
a decentralized computer platform including at least one module, a distributed ledger, and a server including a database;
wherein the decentralized computer platform is stored on the database of the server;
wherein the server is in network communication with at least one user device;
wherein the decentralized computer platform is operable to be accessed by the at least one user device;
wherein the decentralized computer network is implemented by the distributed ledger;
wherein the decentralized computer platform is operable to issue a first unique token identifier associated with an asset to create an asset token;
wherein the asset token is assigned a class, wherein the assignment of the class enables the asset token to expose, display, and/or execute at least one property and/or at least one function specific to the class;
wherein the decentralized computer platform is further operable to issue a second unique token identifier, wherein the second unique token identifier is operable to be associated with the at least one asset token to create a composite token;
wherein the decentralized computer platform is operable to add at least one additional asset token to the composite token, wherein the composite token is operable to remove the at least one asset token and/or the at least one additional asset token from the composite token; and
wherein the decentralized computer platform executes at least one internal waterfall logic to process income generated by the composite token, the asset token, and/or the at least one additional asset token.

11. The system of claim 10, wherein issuance of the asset token initiates the deployment of a smart contract for associating the asset token with an asset wallet, wherein the issuance of a composite token initiates the deployment of a smart contract for associating the composite token with a composite wallet, wherein the composite wallet of the composite token includes the asset wallet of the asset token.

12. The system of claim 10, wherein the at least one asset token contains at least one valuation smart contract for calculating the value of the at least one asset token, wherein the at least one asset token is operable to automatically publish the valuation of the at least one asset token to the distributed ledger.

13. The system of claim 10, wherein the assigned asset class of the at least one asset token is not the assigned asset class of the at least one additional asset token.

14. The system of claim 10, wherein the internal waterfall logic is determined by the asset class assignment of the asset token and/or the at least one additional token, wherein the at least one property and/or the at least one function specific to the asset class determines at least one step in the internal waterfall logic.

15. The system of claim 10, wherein execution of the at least one internal waterfall logic is initiated in real-time upon addition of income to the asset token.

16. The system of claim 10, wherein the decentralized computer platform includes at least one plug-in point, wherein at least one logic, at least one smart contract, and/or at least one updated module is operable to be added to the decentralized computer platform via the at least one plug-in point.

17. A method of processing income generated by tokenized assets, comprising:
issuing an asset token on a decentralized platform, the steps comprising;
issuing a unique token identifier associated with an asset, wherein the unique token identifier is associated with the asset;
assigning an asset class to the asset token and associating a set of properties and/or functions with the asset token based on properties and/or functions of the assigned asset class; and
associating a wallet with the asset token;
adding at least one additional asset token to the wallet associated with the asset token to create a composite token;
publishing the unique token identifier to a distributed ledger which implements the decentralized computer platform;
determining a value of the composite token in real time;
creating an internal waterfall logic by linking a series of smart contracts, wherein deployment of a first smart contract of the series of smart contracts initiates deployment of a second smart contract of the series of smart contracts; and
applying the internal waterfall logic to the composite token, wherein deployment of a first smart contract is initiated by a calculated increase in the value of the composite token.

18. The method of claim 17, wherein the decentralized computer platform is operable to publish the value of the composite token to the distributed ledger continuously and/or in time-based intervals.

19. The method of claim 17, wherein the internal waterfall logic is determined by the asset class assignment of the asset token and/or the at least one additional asset token, wherein the set of properties and/or functions specific to the asset class determines at least one of the smart contracts in the internal waterfall logic.

20. The method of claim 17, wherein the wallet is operable to divide the asset token into at least two shares, wherein at least one of the at least two shares is retained within the wallet, wherein at least one of the at least two shares is transferred to a second wallet.
